(19) United States
(12) Patent Application Publication
(10) Pub. No.: US 2025/0278039 A1
(43) Pub. Date: Sep. 4, 2025

(54) IMAGE FORMING APPARATUS AND TONER REPLENISHMENT CONTROL METHOD IN IMAGE FORMING APPARATUS

(71) Applicant: SHARP KABUSHIKI KAISHA, Sakai City (JP)

(72) Inventor: SHOHEI FUKUMOTO, Sakai City (JP)

(21) Appl. No.: 19/064,971

(22) Filed: Feb. 27, 2025

(30) Foreign Application Priority Data
Mar. 1, 2024 (JP) 2024-030896

(51) Int. Cl. G03G 15/08; G03G 15/00

(52) U.S. Cl. CPC G03G 15/0875; G03G 15/556; G03G 2215/068

(57) ABSTRACT

According to the image forming apparatus according to the present disclosure, when at least one of accumulation necessary replenishment times of two types of toner becomes equal to or greater than a toner replenishment threshold, replenishment of the one toner is performed. The replenishment of this one toner is performed for the accumulation necessary replenishment time of the one toner with a continuous replenishment allowable time as an upper limit. Thereafter, according to the accumulation necessary replenishment time of the other toner and the current accumulation necessary replenishment time of the one toner, the replenishment of the other toner is performed, the replenishment of the one toner is resumed, or the replenishment of both toners is brought into a stop state.

### TECHNICAL FIELD

The present disclosure relates to an image forming apparatus and a toner replenishment control method in the image forming apparatus, and particularly relates to an image forming apparatus and a toner replenishment control method in the image forming apparatus that perform color image formation processing by an electrophotographic method.

### BACKGROUND ART

This type of image forming apparatus is generally provided with four development apparatuses responsible for development of four colors of yellow (Y), magenta (M), cyan (C), and black (K). When development is performed by each development apparatus, toner is consumed, but each development apparatus is replenished with the toner in order to compensate for consumption of this toner. The replenishment of this toner is performed by a toner replenishment apparatus, and there is a toner replenishment apparatus having a configuration in which toner replenishment of two colors of four colors is performed by one (common) drive source, and toner replenishment of the other two colors is performed by another drive source. According to this configuration, since the number of drive sources is reduced, cost reduction of the entire image forming apparatus including the toner replenishment apparatus is achieved. On the other hand, since each drive source selectively performs toner replenishment of two colors, it is not possible to simultaneously perform toner replenishment of the two colors. Therefore, it is important for each drive source to perform toner replenishment of two colors performed by the drive source in good balance.

There is a technique in which the amount of a first developer to be supplied to a first development apparatus is calculated, the amount of a second developer to be supplied to a second development apparatus is calculated, a first drive time for driving a first developer supply member responsible for supply of the first developer and a second drive time for driving a second developer supply member responsible for supply of the second developer are allocated according to the ratio between the amount of the first developer and the amount of the second developer that are calculated, and the first developer supply member and the second developer supply member are selectively driven according to this allocated time. This technique reduces the density variation of the developer is reduced, and reduces the disadvantage that, for example, the density of the developer of one of the first development apparatus and the second development apparatus increases and the density of the developer of the other becomes insufficient.

### SUMMARY

### Technical Problem

In the technique described above, the first drive time for driving the first developer supply member for supply of the first developer and the second drive time for driving the second developer supply member for supply of the second developer are allocated according to the ratio between the amount of the first developer to be supplied to the first development apparatus and the amount of the second developer to be supplied to the second development apparatus. That is, at least processing (calculation) that obtains the ratio and processing that allocates the first drive time and the second drive time according to the ratio are performed. The replenishment manner of the toner including these processing is accordingly complicated, and it is necessary to have a means, such as a CPU responsible for the processing, that has a corresponding ability (performance). This leads to an increase in cost (increase in price) of the entire image forming apparatus, in other words, hinders a reduction in cost of the entire image forming apparatus due to a reduction in the number of drive sources.

Therefore, an object of the present disclosure is to provide a novel technique that can perform two types of toner replenishment in good balance with an extremely simple and uncomplicated manner in an image forming apparatus having a configuration in which two types of toner replenishment are performed by one drive source and a toner replenishment control method in the image forming apparatus.

### Solution to Problem

In order to achieve this object, the present disclosure includes a first disclosure relating to an image forming apparatus and a second disclosure relating to a toner replenishment control method in the image forming apparatus.

The first disclosure is an image forming apparatus that performs image formation processing by an electrophotographic method, and includes a first accommodation, a first replenishment member, a second accommodation, a second replenishment member, a drive source, a drive controller, a derivator, and an accumulator. The first accommodation accommodates a first toner. The first replenishment member replenishes the first toner accommodated in the first accommodation to a first development unit. The second accommodation accommodates second toner. The second replenishment member replenishes the second toner accommodated in the second accommodation to a second development unit. The drive source selectively drives the first replenishment member and the second replenishment member. The drive controller controls the drive source. The derivator derives a first necessary replenishment time and a second necessary replenishment time based on image data to be subjected to the image formation processing. The first necessary replenishment time is a replenishment time of the first toner necessary for compensating for consumption of the first toner consumed by the first development unit. The second necessary replenishment time is a replenishment time of the second toner necessary for compensating for the consumption of the second toner consumed by the second development unit. The accumulator accumulates a shortage of an actual replenishment time of the first toner by the first replenishment member with respect to the first necessary replenishment time every time the image formation processing is performed and obtains a first accumulation time which is an accumulation value of the shortage. Also, the accumulator accumulates a shortage of an actual replenishment time of the second toner by the second replenishment member with respect to the second necessary replenishment time every time the image formation processing is performed and obtains a second accumulation time which is an accumulation value of the shortage.

Here, when at least one of the first accumulation time and the second accumulation time is equal to or greater than a predetermined first threshold, the drive controller specifies the first accumulation time or the second accumulation time that is equal to or greater than the first threshold as one accumulation time, and specifies the first replenishment member or the second replenishment member related to the one accumulation time as one replenishment member. The drive controller drives the one replenishment member for the one accumulation time with a predetermined second threshold as an upper limit, and then stops drive of the one replenishment member. Furthermore, according to the other accumulation time, which is not the one accumulation time, of the first accumulation time and the second accumulation time and the current one accumulation time, the drive controller controls the drive source so as to drive the other replenishment member, which is not the one replenishment member, of the first replenishment member and the second replenishment member, or drives the one replenishment member again, or bring the one replenishment member and the other replenishment member into a stop state without driving both of the one replenishment member and the other replenishment member. In particular, when the other replenishment member is driven, the other replenishment member is driven for the other accumulation time with the second threshold as an upper limit. When the one replenishment member is driven again, the one replenishment member is driven for the current one accumulation time with the second threshold as an upper limit.

When both the first accumulation time and the second accumulation time are equal to or greater than the first threshold, the drive controller specifies the longer one of the first accumulation time and the second accumulation time as the one accumulation time.

In the present first disclosure, a first toner density detector and a second toner density detector may be further included. The first toner density detector detects the density of the first toner contained in a developer in the first development unit, and the second toner density detector detects the density of the second toner contained in a developer in the second development unit. When both the first accumulation time and the second accumulation time are equal to or greater than the first threshold and when the first accumulation time and the second accumulation time have a length equal to each other, the drive controller specifies, as the one accumulation time, the first accumulation time or the second accumulation time corresponding to a lower one of a density detection value by the first toner density detector and a density detection value by the second toner density detector.

The second threshold in the present first disclosure is desirably equal to or greater than the first necessary replenishment time in a case where a printing rate related to the first toner based on the image data is 50% and equal to or less than the first necessary replenishment time in a case where the printing rate is 90%. In other words, the second threshold is desirably a value equal to or greater than the second necessary replenishment time in a case where the printing rate related to the second toner based on the image data is 50% and equal to or less than the second necessary replenishment time in a case where the printing rate is 90%.

In addition, when at least one of the first accumulation time and the second accumulation time is equal to or greater than a predetermined third threshold, the drive controller desirably controls the drive source so as to interrupt the image formation processing, drive the first replenishment member for the first accumulation time, and drive the second replenishment member for the second accumulation time, that is, execute forced replenishment. The third threshold is a value larger (corresponding to a long time) than the first threshold and the second threshold.

The second disclosure of the present disclosure is a toner replenishment control method in an image forming apparatus that performs image formation processing by an electrophotographic method, and includes a drive control step, a derivation step, and an accumulation step. Here, the image forming apparatus includes the first accommodation, the first replenishment member, the second accommodation, the second replenishment member, and the drive source. The first accommodation accommodates the first toner. The first replenishment member replenishes the first toner accommodated in the first accommodation to the first development unit. The second accommodation accommodates the second toner. The second replenishment member replenishes the second toner accommodated in the second accommodation to the second development unit. The drive source selectively drives the first replenishment member and the second replenishment member. Then, the drive control step includes controlling the drive source. The derivation step includes deriving the first necessary replenishment time and the second necessary replenishment time based on the image data to be subjected to the image formation processing. The first necessary replenishment time is a replenishment time of the first toner necessary for compensating for consumption of the first toner consumed by the first development unit. The second necessary replenishment time is a replenishment time of the second toner necessary for compensating for the consumption of the second toner consumed by the second development unit. Furthermore, the accumulation step includes accumulating a shortage of an actual replenishment time of the first toner by the first replenishment member with respect to the first necessary replenishment time every time the image formation processing is performed and obtaining a first accumulation time, which is an accumulation value of the shortage. Also, the accumulation step includes accumulating a shortage of an actual replenishment time of the second toner by the second replenishment member with respect to the second necessary replenishment time every time the image formation processing is performed and obtaining a second accumulation time which is an accumulation value of the shortage.

The drive control step includes, when at least one of the first accumulation time and the second accumulation time is equal to or greater than a predetermined first threshold, specifying the first accumulation time or the second accumulation time that is equal to or greater than the first threshold as one accumulation time, and specifying the first replenishment member or the second replenishment member related to the one accumulation time as one replenishment member. The drive control step includes driving the one replenishment member for the one accumulation time with a predetermined second threshold as an upper limit, and then stopping drive of the one replenishment member. Furthermore, the drive control step includes, according to the other accumulation time, which is not the one accumulation time, of the first accumulation time and the second accumulation time and the current one accumulation time, controlling the drive source so as to drive the other replenishment member, which is not the one replenishment member, of the first replenishment member and the second replenishment member, or driving the one replenishment member again, or bringing the one replenishment member and the other replenishment member into a stop state without driving both of the one replenishment member and the other replenishment member. In particular, when the other replenishment member is driven, the other replenishment member is driven for the other accumulation time with the second threshold as an upper limit. When the one replenishment member is driven again, the one replenishment member is driven for the current one accumulation time with the second threshold as an upper limit.

### Advantageous Effects of Disclosure

According to the present disclosure, it is possible to replenish two types of toner of the first toner and the second toner in good balance with an extremely simple and uncomplicated manner as compared with the technique disclosed in Patent Document 1 described above. This is extremely advantageous for an image forming apparatus having a configuration of achieving cost reduction by replenishing two types of toner by one drive source.

### BRIEF DESCRIPTION OF DRAWINGS

FIG. 1 is a view schematically illustrating an internal configuration of an image forming apparatus according to a first example of the present disclosure.

FIG. 2 is a perspective view of a toner replenishment apparatus in the first example.

FIG. 3 is a perspective cross-sectional view of the toner replenishment apparatus in the first example.

FIG. 4 is a view that describes an operation of the toner replenishment apparatus in the first example.

FIG. 5 is a view illustrating an example of a relationship between a printing timing and a toner replenishment timing in the first example.

FIG. 6 is a view that describes an example of a toner replenishment manner in the first example.

FIG. 7 is a view that describes another example of the toner replenishment manner in the first example.

FIG. 8 is a block diagram illustrating an electrical configuration of the image forming apparatus according to the first example.

FIG. 9 is a flowchart showing a flow of a toner replenishment control task in the first example.

FIG. 10 is a flowchart showing a flow of a part of toner replenishment processing in the first example.

FIG. 11 is a flowchart showing a flow of another part of the toner replenishment processing in the first example.

FIG. 12 is a flowchart showing a flow of the remaining part of the toner replenishment processing in the first example.

FIG. 13 is a view conceptually illustrating a configuration of a forced replenishment threshold table in a second example of the present disclosure.

FIG. 14 is a view conceptually illustrating a configuration of a threshold coefficient table according to a third example of the present disclosure.

### DESCRIPTION OF EMBODIMENTS

### First Example

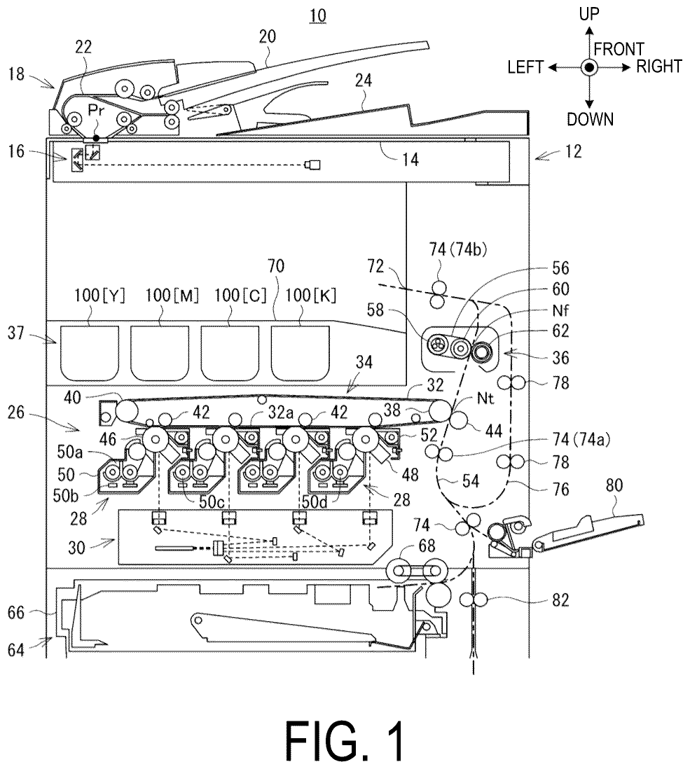

The first example of the present disclosure will be described with an image forming apparatus 10 illustrated in FIG. 1 as an example.

The image forming apparatus 10 according to the present first example is what is called a multifunction peripheral (MFP) having a plurality of functions such as a copy function, a print function, an image scanner function, and a fax function. FIG. 1 is a view of an internal configuration of the image forming apparatus 10 installed in a usable state, viewed from a front side of the image forming apparatus 10. That is, an up-down direction in FIG. 1 corresponds to an up-down direction of the image forming apparatus 10. A left-right direction in FIG. 1 corresponds to a left-right direction of the image forming apparatus 10. Furthermore, a front side of the sheet surface in FIG. 1 corresponds to the front of the image forming apparatus 10. A back side of the sheet surface in FIG. 1 corresponds to the rear of the image forming apparatus 10.

An upper portion of the image forming apparatus 10 is provided with an image reader 12 as an image reader. The image reader 12 performs image read processing of reading an image of a document not illustrated and outputting two-dimensional read image data corresponding to the image of the document. Therefore, the image reader 12 includes a document table 14 on which a document is placed. The document table 14 is formed of a transparent member such as glass having a substantially rectangular flat plate shape, and is provided so that both main surfaces thereof are arranged along a horizontal direction. An image reading unit 16 is provided below the document table 14. Although not described in detail, the image reading unit 16 includes a light source, a mirror, a lens, and a line sensor, and includes an image reading position Pr having a linear shape extending along a front-rear direction of the image forming apparatus 10 on an upper surface of the document table 14. Furthermore, a drive mechanism not illustrated that causes the image reading position Pr of the image reading unit 16 to move (scan) along the left-right direction of the image forming apparatus 10 is provided below the document table 14. That is, when the image reading position Pr of the image reading unit 16 is moved by the drive mechanism in a state where a document is placed on the document table 14, an image of the document is read by what is called a fixed reading method. The front-rear direction of the image forming apparatus 10 is called a main scanning direction. The left-right direction of the image forming apparatus 10 is called a sub-scanning direction.

An automatic document feeder (ADF) 18 that also serves as a document pressing cover for pressing the document placed on the document table 14 is provided above the document table 14. The automatic document feeder 18 is provided so as to be able to transition between a state of exposing the upper surface of the document table 14 to the outside and a state of covering the upper surface of the document table 14. Therefore, the automatic document feeder 18 is joined to a main body (housing) of the image forming apparatus 10 via an appropriate movable support member such as a hinge not illustrated. FIG. 1 illustrates a state where the automatic document feeder 18 covers the upper surface of the document table 14. The automatic document feeder 18 exhibits its original function when it is in a state of covering the upper surface of the document table 14 as illustrated in FIG. 1.

The automatic document feeder 18 includes a document placement tray 20. On the document placement tray 20, a document, more precisely, a sheet-like document can be placed, and in particular, a plurality of documents can be placed in a stacked manner. Although not described in detail, the automatic document feeder 18 takes in documents placed on the document placement tray 20 one by one (one document at a time), and conveys the documents on a document conveyance path 22 in the automatic document feeder 18. In the middle thereof, the document passes through the image reading position Pr, and more precisely, passes through the image reading position Pr that is in a fixed state. Thus, the image of the document is read by what is called a flow reading method. Afterwards, the document is discharged to a document discharge tray 24.

An image former 26 as an image former is provided below the image reader 12. The image former 26 performs image formation processing of forming an image based on appropriate image data such as the above-described read image data onto a sheet-like image recording medium not illustrated, for example, a paper sheet. That is, the image former 26 performs printing. This printing is performed by a known electrophotographic method. The image former 26 employs a tandem method to perform color printing.

Specifically, the image former 26 includes four process units (also called “image forming stations”) 28, 28, . . . as monochrome toner image formers that individually form monochrome toner images, not illustrated, of a plurality of different colors, for example, four colors of yellow, magenta, cyan, and black. In addition, the image former 26 includes an exposure apparatus 30 as an exposure means that performs exposure necessary for formation of a monochrome toner image by each of the process units 28, 28, . . . . Furthermore, the image former 26 includes a transfer unit 34 as a transfer means. The transfer unit 34 includes an intermediate transfer belt 32 (also called a “primary transfer belt”) to which the monochrome toner images formed by the respective process units 28, 28, . . . are sequentially transferred, and transfers, onto a sheet, the toner image transferred to the intermediate transfer belt 32. In addition, the image former 26 includes a fixing apparatus 36 as a fixer that fixes, on the sheet, the toner image transferred onto the sheet. Moreover, the image former 26 includes a toner replenishment apparatus 37 that replenishes toner not illustrated onto development apparatuses 50, 50, . . . described later of the respective process units 28, 28, . . .

First, the transfer unit 34 will be described in detail. The transfer unit 34 includes, in addition to the intermediate transfer belt 32 described above, a driving roller 38 that rotates the intermediate transfer belt 32, and a driven roller 40 that stretches the intermediate transfer belt 32 together with the driving roller 38. Furthermore, the transfer unit 34 includes four intermediate transfer rollers (also called “primary transfer rollers”) 42, 42, . . . provided at positions corresponding to the respective process units 28, 28, . . . on an inner side of the intermediate transfer belt 32, and a transfer roller (also called “secondary transfer roller”) 44 as a transfer member.

The intermediate transfer belt 32 is stretched by the driving roller 38 and the driven roller 40. The driving roller 38 rotates by receiving a driving force from a motor as an intermediate transfer belt driver not illustrated, and rotates counterclockwise in FIG. 1, for example. Together with this, the intermediate transfer belt 32 rotates (circulates) in the same direction, and the driven roller 40 also rotates in the same direction. A region 32a on a lower side of the region between the driving roller 38 and the driven roller 40 in the intermediate transfer belt 32 is stretched along the horizontal direction, and the process units 28, 28, . . . are arranged to face the region 32a stretched along this horizontal direction. The region 32a where the process units 28, 28, . . . are arranged in the intermediate transfer belt 32 is called an intermediate transfer region. In this intermediate transfer region 32a, the intermediate transfer belt 32 moves from the left side to the right side of the image forming apparatus 10, that is, along the sub-scanning direction.

The intermediate transfer belt 32 is an endless belt-type body having flexibility and is made of a synthetic resin (e.g., polyimide or polycarbonate) to which a conductive material such as carbon black is appropriately mixed. Although not described in detail, the driven roller 40 also has a slack prevention function of preventing slack of the intermediate transfer belt 32 by applying an appropriate tension to the intermediate transfer belt 32.

The process units 28, 28, . . . are provided at constant intervals below the intermediate transfer region 32a of the intermediate transfer belt 32 along the movement direction of the intermediate transfer belt 32 in the intermediate transfer region 32a, that is, along the sub-scanning direction. As described above, the process units 28, 28, . . . each form, onto the intermediate transfer belt 32, an individual monochrome toner image of four colors of yellow, magenta, cyan, and black. Although not apparent from the drawings including FIG. 1, the process units 28, 28, . . . are provided in order of yellow, magenta, cyan, and black from the upstream side to the downstream side (from the left side to the right side in FIG. 1) in the movement direction of the intermediate transfer belt 32 in the intermediate transfer region 32a. However, this order is merely an example while not limited thereto. The process units 28, 28, . . . have the same structure as each other, except for each forming a monochrome toner image of a different color on the intermediate transfer belt 32.

Each of the process units 28 includes a photoconductive drum 46, a charging apparatus 48, a development apparatus 50, a cleaning apparatus 52, and a static elimination apparatus not illustrated.

The photoconductive drum 46 is an image carrier that carries an electrostatic latent image and a monochrome toner image described later, and includes a cylindrical base formed of a conductive material such as aluminum. Although not illustrated, the base is grounded, and a photosensitive layer is formed on a surface (outer peripheral surface) of the base. The photoconductive drum 46 is provided in the intermediate transfer region 32a so as to bring the surface of the base into contact with the outer surface of the intermediate transfer belt 32, and rotates by receiving a driving force from a motor as a drum driver not illustrated. The rotation direction is clockwise in FIG. 1. The photoconductive drum 46 rotates at a speed corresponding to the moving speed of the intermediate transfer belt 32.

The charging apparatus 48 is a charger that charges the surface of the photoconductive drum 46 to a predetermined potential. The surface of the photoconductive drum 46 charged to a predetermined potential by this charging apparatus 48 is exposed by the exposure apparatus 30 described above, and the exposed region of the surface of the photoconductive drum 46 is lowered to a potential close to the ground potential (OV). The exposure apparatus 30 is provided below the line of the process units 28, 28, . . . and exposes the surface of the photoconductive drum 46 of each of the process units 28 from below. That is, the exposure apparatus 30 irradiates the surface of the photoconductive drum 46 with light of an aspect in accordance with image data to be printed. Thus, an electrostatic latent image having a surface potential changed in accordance with image data to be printed is formed on the surface of the photoconductive drum 46. The exposure apparatus 30 is a laser scanning unit including a laser diode not illustrated as a light source, for example, and a polygon mirror as a deflector. However, in place of this, an LED unit including an LED array in which LEDs as light sources are arranged may be employed as the exposure apparatus 30.

The development apparatus 50 is a development unit that develops the electrostatic latent image formed on the surface of the photoconductive drum 46. That is, the development apparatus 50 includes a developer accommodation chamber 50a, and this developer accommodation chamber 50a accommodates a developer containing toner. The developer accommodated in this developer accommodation chamber 50a is stirred by stirring members 50c and 50d provided in the developer accommodation chamber 50a. Thus, the toner contained in the developer is frictionally charged, and the development apparatus 50 develops the electrostatic latent image on the photoconductive drum 46 with this charged toner. In other words, the electrostatic latent image formed on the photoconductive drum 46 is visualized as a monochrome toner image by the toner contained in the developer accommodated in the development apparatus 50 (developer accommodation chamber 50a). The developer is a two-component developer containing a carrier in addition to the toner. The toner is a non-magnetic material, and the carrier is a magnetic material. A toner density sensor 50b as a toner density detector a density (mass ratio of toner to carrier) T/D of toner contained in the developer in the developer accommodation chamber 50a is provided below the developer accommodation chamber 50a. This toner density sensor 50b is what is called a permeability sensor, and detects the bulk density of the carrier contained in the developer by measuring the permeability of the developer, and eventually detects the toner density T/D.

The monochrome toner image visualized by development by this development apparatus 50 is transferred from the surface of the photoconductive drum 46 to the outer surface of the intermediate transfer belt 32 at a contact position between the surface of the photoconductive drum 46 and the outer surface of the intermediate transfer belt 32, that is, the monochrome toner image is transferred by so-called intermediate transfer (primary transfer). Therefore, an intermediate transfer roller 42 is provided so as to face the photoconductive drums 46 across the intermediate transfer belt 32. The intermediate transfer roller 42 is provided such that the surface (outer peripheral surface) thereof is in contact with the inner surface of the intermediate transfer belt 32, and rotates by receiving a driving force generated by the rotation of the intermediate transfer belt 32, that is, rotates counterclockwise in FIG. 1. When the intermediate transfer roller 42 is applied with a predetermined intermediate transfer voltage from an intermediate transfer power source not illustrated, a transfer electric field is formed between the surface of the photoconductive drum 46 and the outer surface of the intermediate transfer belt 32. By the action of this transfer electric field, the monochrome toner image on the photoconductive drum 46 is transferred onto the intermediate transfer belt 32.

In this manner, monochrome toner images of the four colors of yellow, magenta, cyan, and black are individually formed on the intermediate transfer belt 32. A color toner image is formed on the intermediate transfer belt 32 by the monochrome toner images of the four colors being superimposed on each other.

The (color) toner image formed on the intermediate transfer belt 32 is transferred to a sheet at a transfer nip Nt which is a contact part between the intermediate transfer belt 32 and the transfer roller 44. Specifically, the transfer roller 44 is provided so as to press the intermediate transfer belt 32 between the transfer roller 44 and the driving roller 38 at a position facing the driving roller 38 across the intermediate transfer belt 32. The transfer roller 44 rotates by receiving a driving force generated by the rotation of the intermediate transfer belt 32, that is, rotates clockwise in FIG. 1. Then, a transfer bias current having the same polarity as the toner charging polarity is applied from a transfer bias power source not illustrated to the driving roller 38. Thus, a transfer electric field is formed between the intermediate transfer belt 32 and the transfer roller 44, that is, at the transfer nip Nt. When the sheet passes through the transfer nip Nt in this state, the toner image on the intermediate transfer belt 32 is transferred onto the sheet.

The cleaning apparatus 52 is a cleaner that removes residual toner on the photoconductive drum 46 after the monochrome toner image is transferred from the photoconductive drum 46 onto the intermediate transfer belt 32. The static elimination apparatus not illustrated is a static eliminator that removes static electricity on the photoconductive drum 46 after the residual toner is removed by the cleaning apparatus 52. After the static electricity is removed by this static eliminator, the process subsequent to the charging by the charging apparatus 48 described above is repeated.

The fixing apparatus 36 is provided on a downstream side relative to the transfer nip Nt in a conveyance direction of the sheet conveyed along a sheet conveyance path 54 described later. As described above, the fixing apparatus 36 fixes, on the sheet, the toner image on the sheet, specifically, heats and melts the toner image, and further presses the toner image, thereby fixing (thermally fixing) the toner image on the sheet. Therefore, the fixing apparatus 36 includes a heating belt 56, a heating roller 58, a fixing roller 60, and a pressure roller 62.

The heating belt 56 is an endless belt-type body having flexibility and is made of a synthetic resin (e.g., polyimide or polycarbonate) having high thermal conductivity. This heating belt 56 is stretched by the heating roller 58 and the fixing roller 60. The heating roller 58 includes a cylindrical base (heat conductive layer) having high thermal conductivity, and a heat source is provided inside thereof. The heat source is a lamp heater such as a halogen lamp, and is heated by receiving supply of heating power from a heater heating power source not illustrated. The fixing roller 60 is a columnar roller member and includes a metal core and an elastic layer covering the metal core. That is, the heating roller 58 and the fixing roller 60 extend in a state of being parallel with each other, and are in contact within the heating belt 56. The fixing roller 60 rotates by receiving a driving force from a motor as a heating belt driver not illustrated, and rotates counterclockwise in FIG. 1, for example. Together with this, the heating belt 56 rotates (circulates) in the same direction as the fixing roller 60, and the heating roller 58 also rotates in the same direction as the fixing roller 60.

The pressure roller 62 is a columnar roller member and includes a metal core, an elastic layer covering the metal core, and a release layer covering the elastic layer. The pressure roller 62 is provided so as to press the heating belt 56 between the pressure roller 62 and the fixing roller 60 at a position facing the fixing roller 60 across the heating belt 56. That is, the pressure roller 62 is provided so as to extend along a rotation axis direction of the fixing roller 60, in other words, so as to extend along a rotation axis direction of the heating belt 56. This pressure roller 62 rotates by receiving a driving force generated by the rotation of the heating belt 56, that is, rotates clockwise in FIG. 1. A fixing nip Nf which is a pressing part of the heating belt 56 by the pressure roller 62 is positioned in the sheet conveyance path 54 described later. When the sheet passes through this fixing nip Nf, the toner image on the sheet is heated and melted, further pressed, and fixed on the sheet.

Although not described in detail including drawings, the fixing apparatus 36 includes a temperature sensor that detects a surface temperature (fixing temperature) of the heating belt 56. Based on a detection result by this temperature sensor, the heating temperature of the heating roller 58 by the above-described heat source is controlled, and thus, the surface temperature of the heating belt 56 is controlled. For example, a thermistor is used as the temperature sensor, but the temperature sensor is not limited to the thermistor. In the fixing apparatus 36, a configuration may be employed in which the heating belt 56 is not provided, the fixing roller 60 also serves as the heating roller 58, and a direct contact part between the fixing roller 60 and the pressure roller 62 serves as the fixing nip Nf.

The toner replenishment apparatus 37 replenishes toner to each of the development apparatuses 50, 50, . . . , more specifically, to the developer accommodation chamber 50a of each of the development apparatuses 50. That is, when development is performed by each development apparatus 50, the toner in the developer accommodation chamber 50a of each development apparatus 50 is consumed. In order to compensate for consumption of the toner, the toner replenishment apparatus 37 replenishes the toner to the developer accommodation chamber 50a of each development apparatus 50. Although the toner replenishment apparatus 37 will be described in detail later, the toner replenishment apparatus 37 is mounted with four toner cartridges 100, 100, . . . accommodating toner corresponding to the above-described four colors.

Furthermore, a sheet feeder 64 as a sheet feed means is provided below the image former 26, in other words, below the image forming apparatus 10. The sheet feeder 64 includes a sheet feeding cassette 66, and a plurality of sheets can be accommodated in this sheet feeding cassette 66 in a stacked manner. In addition, the sheet feeder 64 includes a pickup roller 68. The sheet feeder 64 takes out, one by one by the pickup roller 68, sheets accommodated in the sheet feeding cassette 66, and supplies the sheets to the sheet conveyance path 54 described next.

The sheet conveyance path 54 is provided from the sheet feeder 64, via the transfer nip Nt and the fixing nip Nf, to a sheet discharge port 72 leading to a sheet discharge tray 70. Appropriate positions of the sheet conveyance path 54 are provided with a plurality of conveyance rollers (strictly speaking, roller pairs) 74, 74, . . . that convey sheets along the sheet conveyance path 54 from the sheet feeder 64 toward the sheet discharge port 72. Among the conveyance rollers 74, 74, . . . , a conveyance roller 74a provided at a position closest to the transfer nip Nt on an upstream side relative to the transfer nip Nt in the conveyance direction of the sheet in the sheet conveyance path 54 is a resist roller (also called “paper stop roller”) that measures a timing at which the sheet passes through the transfer nip Nt. Of the conveyance rollers 74, 74, . . . , a conveyance roller 74b provided at the most distal downstream position in the conveyance direction of the sheet in the sheet conveyance path 54, that is, in the vicinity of the sheet discharge port 72, is a sheet discharge roller that discharges the sheet to the sheet discharge tray 70 via the sheet discharge port 72. The sheet discharge tray 70 is provided between the image reader 12 and the image former 26, that is, provided in what is called an in-body space while not limited thereto.

In addition, a reverse conveyance path 76 for double-sided printing is provided in the image forming apparatus 10. This reverse conveyance path 76 is a conveyance path in which a sheet that has once passed through the fixing nip Nf, that is, a sheet after printing is taken in, and the sheet is provided for printing again. That is, the sheet taken into the reverse conveyance path 76 is supplied to the sheet conveyance path 54 again via the reverse conveyance path 76, and specifically, is supplied to the upstream side of a resist roller 74a. Thus, the sheet supplied to the upstream side of the resist roller 74a is brought into a state where the front and back of the sheet are reversed. Printing is performed on this sheet that has been turned over, and what is called double-sided printing is achieved. An appropriate position of the reverse conveyance path 76 is also provided with a conveyance roller 78.

A right side surface of the image forming apparatus 10 is provided with a manual feed tray 80. A plurality of sheets can be placed on this manual feed tray 80 in a stacked manner. When this manual feed tray 80 is designated as a sheet supply source, the sheet feeder 64 supplies sheets one by one from the manual feed tray 80 to the sheet conveyance path 54.

Moreover, the sheet feeder 64 may include an optional sheet feeding cassette not illustrated. This optional sheet feeding cassette is provided below the sheet feeding cassette 66. When the optional sheet feeding cassette is designated as a sheet supply source, the sheet feeder 64 supplies sheets one by one from the optional sheet feeding cassette to the sheet conveyance path 54. An optional conveyance roller 82 that supplies a sheet from the optional sheet feeding cassette to the sheet conveyance path 54 is provided at an appropriate position.

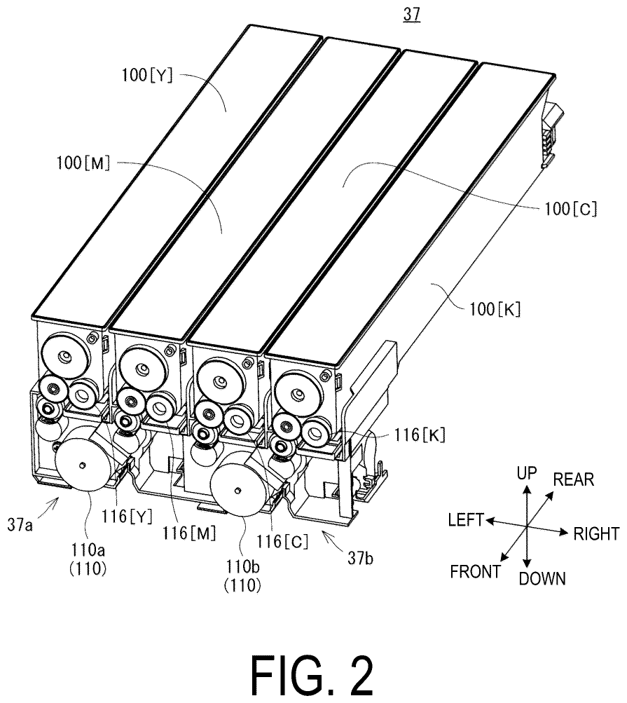

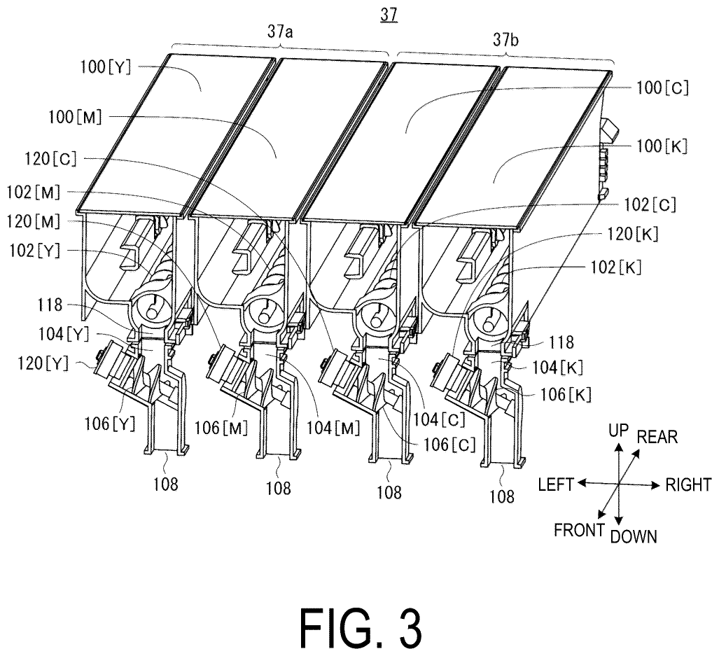

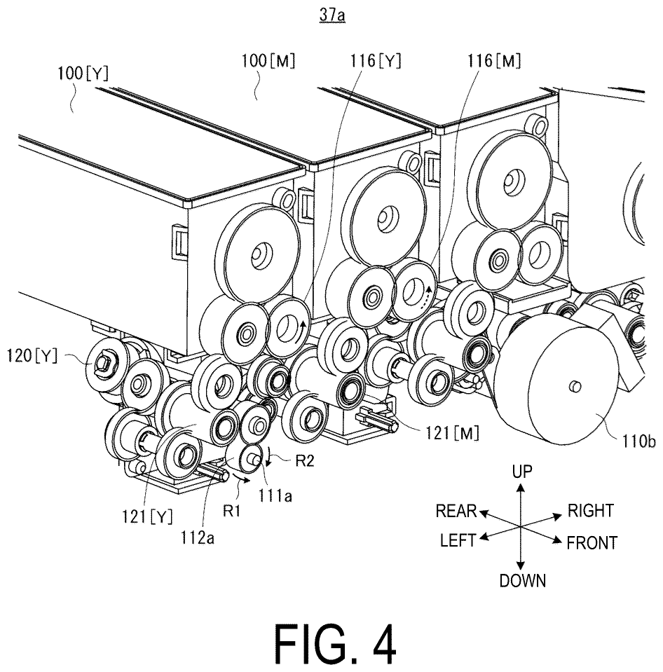

Next, the toner replenishment apparatus 37 will be described in detail with reference to FIGS. 2 to 4. Here, FIG. 2 is a perspective view of the toner replenishment apparatus 37 as viewed from the front right oblique upper side. FIG. 3 is a cross-sectional view of the toner replenishment apparatus as viewed from an obliquely upper right front side at an angle slightly different from that in FIG. 2. FIG. 4 is a view illustrating a transmission path of a rotational force from a drive source 110 described later.

The toner replenishment apparatus 37 included in the image forming apparatus 10 according to the first example includes two replenishment apparatuses of a first replenishment apparatus 37a and a second replenishment apparatus 37b. Of them, the first replenishment apparatus 37a is responsible for toner replenishment of two colors of yellow and magenta. For this purpose, the first replenishment apparatus 37a includes the toner cartridge 100 (hereinafter, may be called “yellow toner cartridge 100[Y]”) as an accommodation for yellow toner in which yellow toner is accommodated, the toner cartridge 100 (hereinafter, may be called “magenta toner cartridge 100[M]”) as an accommodation for magenta toner in which magenta toner is accommodated, a first replenishment motor 110a that is the drive source 110 that replenishes toner from the toner cartridges 100[Y] and 100[M] to the respective development apparatuses 50, and internal replenishment paths 104 [Y] and 104 [M] through which toner is guided from the toner cartridges 100[Y] and 100[M] to the respective development apparatuses 50. The toner cartridges 100[Y] and 100[M], the first replenishment motor 110a, and the internal replenishment paths 104 [Y] and 104 [M] are attached to the main body of the image forming apparatus 10, but the toner cartridges 100[Y] and 100[M] are easily and detachably attached to the main body of the image forming apparatus 10 so as to be replaceable when the toner therein runs out.

On the other hand, the second replenishment apparatus 37b is responsible for toner replenishment of two colors of cyan and black. For this purpose, the second replenishment apparatus 37b includes the toner cartridge 100 (hereinafter, may be called “cyan toner cartridge 100[C]”) as an accommodation for cyan toner in which cyan toner is accommodated, the toner cartridge 100 (hereinafter, may be called “black toner cartridge 100[K]”) as an accommodation for black toner in which black toner is accommodated, a second replenishment motor 110b that is the drive source 110 that replenishes toner from the toner cartridges 100[C] and 100[K] to the respective development apparatuses 50, and internal replenishment paths 104 [C] and 104 [K] through which toner is guided from the toner cartridges 100[C] and 100[K] to the respective development apparatuses 50. The toner cartridges 100[C] and 100[K], the second replenishment motor 110b, and the internal replenishment paths 104 [C] and 104 [K] are attached to the main body of the image forming apparatus 10, but the toner cartridges 100[C] and 100[K] are easily and detachably attached to the main body of the image forming apparatus 10 so as to be replaceable when the toner therein runs out.

Each of the toner cartridges 100 is internally provided with a conveyance replenishment member (auger screw) 102 that conveys the toner accommodated in the toner cartridge 100 forward while stirring the toner (FIG. 3). A first gear 116 is attached to a front end portion of each of the conveyance replenishment members 102 (FIG. 2), and when a rotational force from the corresponding drive source 110 is transmitted to the first gear 116, the conveyance replenishment member 102 rotates. When this conveyance replenishment member 102 rotates, the toner accommodated in the toner cartridge 100 is conveyed forward and sent to the internal replenishment path 104 via a discharge port 118 provided in front of the toner cartridge 100. The internal replenishment path 104 provided so as to correspond to the discharge port 118 of each toner cartridge 100 is provided with a replenishment member (screw feeder) 106. Each replenishment member 106 is also provided with a second gear 120 that receives the rotational force from the corresponding drive source 100 at an end (end in the left direction), and the second gear 120 receives the rotational force from the drive source 110 and rotates at a constant speed, whereby the toner supplied from each toner cartridge 100 via each discharge port 118 is discharged from a replenishment port 108 at a constant speed (Vs[X]). The toner discharged from this replenishment port 108 is replenished to the developer accommodation chamber 50a of the corresponding development apparatus 50 via an external replenishment path not illustrated. Since the black toner is greater in consumption amount than the toner of other colors, the black toner cartridge 100[K] may be larger in size than each of the other toner cartridges 100.

In the first example, the replenishment member 106 is provided between the internal replenishment path 104 and the replenishment port 108, but the internal replenishment path 104 may be configured such that the replenishment member 106 is eliminated and the discharge port 118 is positioned directly above the replenishment port 108. In this case, the toner in the toner cartridge 100 is replenished to the developer accommodation chamber 50a by the rotation of the conveyance replenishment member 102.

Here, the first replenishment apparatus 37a in the first example selectively drives, by the first replenishment motor 110a which is a common (one) drive source, any one of the replenishment member 106 (yellow replenishment member 106[Y]) for the yellow toner cartridge 100[Y] and the conveyance replenishment member 102 (yellow conveyance replenishment member 102[Y]) in the yellow toner cartridge 100[Y], and the replenishment member 106 (magenta replenishment member 106[M]) for the magenta toner cartridge 100[M] and the conveyance replenishment member 102 (magenta conveyance replenishment member 102[M]) in the magenta toner cartridge 100[M]. That is, the first replenishment motor 110a selectively drives the yellow replenishment member 106[Y] and the yellow conveyance replenishment member 102[Y], and the magenta replenishment member 106[M] and the magenta conveyance replenishment member 102[M]. In other words, the first replenishment motor 110a cannot simultaneously drive the yellow replenishment member 106[Y] and the yellow conveyance replenishment member 102[Y], and the magenta replenishment member 106[M] and the magenta conveyance replenishment member 102[M].

More specifically, with reference to FIG. 4, a rotation shaft 110a of the first replenishment motor 111a is provided with a drive gear 112a (in FIG. 4, the first replenishment motor 110a is not illustrated so that the arrangement of the drive gear 112a can be seen). The drive gear 112a is connected with a yellow gear train 121[Y] that transmits a rotational force to the first gear 116 (yellow first gear 116[Y]) attached to the yellow conveyance replenishment member 102[Y] and the second gear 120 (yellow second gear 120[Y]) attached to the yellow replenishment member 106[Y], and a magenta gear train 121[M] that transmits a rotational force to the first gear 116 (magenta first gear 116[M]) attached to the magenta conveyance replenishment member 102[M] and the second gear 120 (magenta second gear 120[M]) attached to the magenta replenishment member 106[M]. Each of the yellow gear train 121[Y] and the magenta gear train 121[M] is provided with one one-way clutch not illustrated in which the direction where the rotational force is transmitted is one direction. Here, the one-way clutch provided in the yellow gear train 121[Y] is arranged so as to transmit the rotational force to the yellow gear train 121[Y] when the drive gear 112a of the first replenishment motor 110a rotates in a predetermined direction R1 (counterclockwise in FIG. 4), but not to transmit the rotational force to the yellow gear train 121[Y] when the drive gear 112a rotates in a direction R2 (clockwise in FIG. 4) opposite to the predetermined direction R1. Similarly, the one-way clutch provided in the magenta gear train 121[M] is arranged so as not to transmit the rotational force to the magenta gear train 121[M] when the drive gear 112a rotates in one direction R1 which is a predetermined direction, and so as to transmit the rotational force to the magenta gear train 121[M] when the drive gear 112a rotates in the other direction R2 which is a direction opposite to the one direction R1. That is, when (the drive gear 112a of) the first replenishment motor 110a rotates in the one direction R1, the yellow replenishment member 106[Y] and the yellow conveyance replenishment member 102[Y] are driven, whereby the yellow toner is replenished to the developer accommodation chamber 50a of the development apparatus 50 for yellow. When the first replenishment motor 110a rotates in the other direction R2, the magenta replenishment member 106[M] and the magenta conveyance replenishment member 102[M] are driven, whereby the magenta toner is replenished to the developer accommodation chamber 50a of the development apparatus 50 for magenta. FIG. 4 is a view illustrating an extracted main part of the first replenishment apparatus 37a. The first replenishment motor 110a is, for example, a stepping motor, but is not limited to this.

Similarly, the second replenishment apparatus 37b in the first example also selectively drives, by the second replenishment motor 110b which is a common (one) drive source, any one of the replenishment member 106 (cyan replenishment member 106[C]) for the cyan toner cartridge 100[C] and the conveyance replenishment member 102 (cyan conveyance replenishment member 102[C]) in the cyan toner cartridge 100[C], and the replenishment member 106 (black replenishment member 106[K]) for the black toner cartridge 100[K] and the conveyance replenishment member 102 (black conveyance replenishment member 102[K]) in the black toner cartridge 100[K]. That is, the second replenishment motor 110b selectively drives the cyan replenishment member 106[C] and the cyan conveyance replenishment member 102[C], and the black replenishment member 106[K] and the black conveyance replenishment member 102[K]. In other words, the second replenishment motor 110b cannot simultaneously drive the cyan replenishment member 106[C] and the cyan conveyance replenishment member 102[C], and the black replenishment member 106[K] and the black conveyance replenishment member 102[K].

A rotation shaft 111b of the second replenishment motor 110b is also provided with a drive gear 112b similar to that provided on the rotation shaft 111a of the first replenishment motor 110a (in FIG. 4, the rotation shaft 111b and the drive gear 112b of the second replenishment motor 110b are blocked by the second replenishment motor 110b and do not appear). The drive gear 112b of the second replenishment motor 110b is also connected with a cyan gear train that constitutes a transmission path through which a rotational force is transmitted to the first gear 116 (cyan first gear 116[C]) attached to the cyan conveyance replenishment member 102[C] and the second gear 120 (cyan second gear 120[C]) attached to the cyan replenishment member 106[C] and is provided with a one-way clutch in the transmission path, and a black gear train that constitutes a transmission path through which a rotational force is transmitted to the first gear 116 (black first gear 116[K]) attached to the black conveyance replenishment member 102[K] and the second gear (black second gear) attached to the black replenishment member 106[K] and is provided with a one-way clutch in the transmission path. Similarly to the first replenishment motor 110a, when (the drive gear 112b of) the second replenishment motor 110b rotates in the one direction R1, the cyan replenishment member 106[C] and the cyan conveyance replenishment member 102[C] are driven, and when the drive gear 112b rotates in the other direction R2, the black replenishment member 106[K] and the black conveyance replenishment member 102[K] are driven to perform replenishment of the respective toner. Similarly to the first replenishment motor 110a, the second replenishment motor 110b is also a stepping motor, for example, but is not limited thereto.

As described above, when each of the replenishment members 106 rotates at a constant speed, the developer accommodation chamber 50a of the corresponding development apparatus 50 is replenished with toner at a constant speed (Vs[X]), but a replenishment speed Vs[X] (X; index representing any of Y, M, C, and K) of this toner has a value at which the toner is not replenished in a lump, and a necessary and sufficient stirring time for charging the replenished toner as intended can be secured. The replenishment speed Vs[X] of the toner of the toner replenishment apparatus 37 in the first example is expressed as a toner amount that can be replenished in a unit time, and the value thereof is, for example, 0.2 g/s. This value can be obtained by experiment, and the replenishment apparatus 37 in the first example drives the replenishment member 106 (and the conveyance replenishment member 102) so that 0.2 g of toner is replenished per second from the replenishment port 108 (and the discharge port 118). The amount of toner to be replenished by the toner replenishment apparatus 37 during toner image formation can be controlled (adjusted) by the drive time of the drive source 110 that drives the replenishment member 106 (and the conveyance replenishment member 102). Next, a toner consumption amount Qc[X] consumed along with the formation of the toner image will be described.

The toner consumption amount Qc[X] can be calculated by the size of the sheet on which the toner image is formed and a printing rate Rp[X]. Here, the toner consumption amount Qc[X] that is actually consumed when the size of the sheet on which the toner image is formed is the A4 size and a toner image in which the printing rate Rp[X] which is the area ratio of the toner image to the size of the sheet is 5% is formed is obtained from the experimental result, and the value thereof is 0.013 g per sheet. Since the toner consumption amount Qc[X] has a correlation with the printing rate Rp[X], the toner consumption amount Qc[X] when the size of the sheet is the A4 size and the printing rate Rp[X] is 100% can be predicted to be 0.26 g per sheet by proportional calculation since the consumption amount Qc[X] at the printing rate Rp[X] 5% is 0.013 g. Thus, since the toner consumption amount Qc[X] can be predicted by the value of the printing rate Rp[X], it is understood that the toner replenishment amount to be replenished by the toner replenishment apparatus 37 may be performed based on the printing rate Rp[X]. The printing rate Rp[X] is obtained by being converted into the A4 size. Therefore, for example, in a case of the A3 size with the printing rate Rp[X] 100%, since the area of A3 is twice of A4, conversion is performed to 200%, that is, for two sheets of A4 size, but thereafter, the size of the sheet is assumed to be the A4 size unless otherwise specified. This toner consumption amount Qc[X] is also common (same) in all the four colors.

Next, the number of printed sheets per minute (CPM) representing the printing speed of the image forming apparatus 10 in the first example is, for example, 35. Therefore, a one-sheet printing time (sheet passing time) Tp (=1/CPM), which is the time required to print one sheet of paper, is about 1.71 s. That is, when an A4 size toner image with the printing rate Rp[X] of 100% is formed, 0.26 g of toner needs to be replenished, but since the toner replenishment rate Vs[X] per unit time of the replenishment apparatus 37 is 0.2 g/S, the time (drive time) required to replenish 0.26 g of toner is 1.3 seconds, and the toner replenishment can be finished within the one-sheet printing time.

Here, focusing on the first replenishment apparatus 37a, according to the first replenishment apparatus 37a, the yellow replenishment member 106[Y] and the magenta replenishment member 106[M] are selectively driven by the first replenishment motor 110a as described above, that is, the replenishment of the yellow toner and the replenishment of the magenta toner are selectively performed. Therefore, for example, when the printing rate Rp[Y] of yellow related to printing on one sheet of paper is 5% and the printing rate Rp[M] of magenta is 5%, that is, when the consumption amount Qc[Y] of the yellow toner is 0.013 g and the consumption amount Qc[M] of the magenta toner is also 0.013 g, the drive time of the yellow replenishment member 106[Y] necessary for compensating for the consumption of the yellow toner, that is, the necessary replenishment time Ts[Y] (=Qc[Y]/Vs[Y]) of the yellow toner is 0.065 s, and the necessary replenishment time Ts[M] (=Qc[M]/Vs[M]) of the magenta toner, which is the drive time of the magenta replenishment member 106[M] for compensating for the consumption of the magenta toner, is also 0.065 s. That is, in order to compensate for the consumption of the yellow toner and the magenta toner by printing, a total time of 0.13 s is required. This time of 0.13 s is shorter than the printing time Tp per sheet of about 1.71 s described above. This means that it is possible to replenish all consumption of the yellow toner and the magenta toner by the printing within the printing time Tp per sheet, in other words, while printing is performed on one sheet.

On the other hand, for example, when the printing rate Rp[Y] of yellow related to printing on one sheet is 100% (yellow solid) and the printing rate Rp[M] of magenta is 100% (magenta solid), that is, when the consumption amount Qc[Y] of the yellow toner is 0.26 g and the consumption amount Qc[M] of the magenta toner is also 0.26 g, the necessary replenishment time Ts[Y] for compensating for the consumption of the yellow toner is 1.3 s, and the necessary replenishment time Ts[M] for compensating for the consumption of the magenta toner is also 1.3 s. That is, in order to compensate for the consumption of the yellow toner and the magenta toner by printing, a total time of 2.6 s is required. This time of 2.6 s is longer than the printing time Tp per sheet of about 1.71 s. This means that it is not possible to replenish all consumption of the yellow toner and the magenta toner by the printing within the printing time Tp per sheet, that is, while printing is performed on one sheet, so to speak, the replenishment is not in time.

Therefore, it is important to drive the yellow replenishment member 106[Y] and the magenta replenishment member 106[M] in an appropriate balance according to the necessary replenishment time Ts[Y] of the yellow toner and the necessary replenishment time Ts[M] of the magenta toner, strictly, according to an accumulation necessary replenishment time Tz[Y] of the yellow toner and an accumulation necessary replenishment time Tz[M] of the magenta toner. The accumulation necessary replenishment time Tz[Y] of the yellow toner is an accumulation value of the shortage in which the drive time (replenishment time of yellow toner) of the actual yellow replenishment member 106[Y] is subtracted from the necessary replenishment time Ts[Y] of the yellow toner. The accumulation necessary replenishment time Tz[M] of the magenta toner is an accumulation value of a shortage of the drive time (replenishment time of the magenta toner) in which the actual magenta replenishment member 106[M] is subtracted from the necessary replenishment time Ts[M] of the magenta toner. These accumulation necessary replenishment times Tz[Y] and Tz[M] are obtained each time printing is performed.

Therefore, in the present first example, for example, when the accumulation necessary replenishment time Tz[Y] of the yellow toner becomes equal to or greater than a toner replenishment threshold Ta as a predetermined first threshold, the yellow replenishment member 106[Y] is driven, that is, replenishment of the yellow toner is performed. This replenishment of the yellow toner is performed for the accumulation necessary replenishment time Tz[Y] with a continuous replenishment allowable time Ton as a predetermined second threshold as an upper limit. That is, when the accumulation necessary replenishment time Tz[Y] is equal to or less than the continuous replenishment allowable time Ton, replenishment of the yellow toner is performed for the accumulation necessary replenishment time Tz[Y]. On the other hand, when the accumulation necessary replenishment time Tz[Y] exceeds the continuous replenishment allowable time Ton, the replenishment of the yellow toner is performed for the continuous replenishment allowable time Ton and then the replenishment of the yellow toner is temporarily stopped. In other words, the replenishment of the yellow toner is temporarily stopped before the replenishment of the yellow toner for the accumulation necessary replenishment time Tz[Y] is completed. After a predetermined replenishment stop time Toff has elapsed, the replenishment of the yellow toner is resumed on condition that the accumulation necessary replenishment time Tz[M] of the magenta toner which is the other toner is less than the toner replenishment threshold Ta. This replenishment of the yellow toner is performed until the accumulation necessary replenishment time Tz[Y] of the yellow toner reaches 0 (zero), strictly, equal to or less than 0. In short, replenishment of the yellow toner is intermittently performed in a pattern in accordance with what is called a replenishment duty (Ton: Toff) formed by a combination of the continuous replenishment allowable time Ton and the replenishment stop time Toff.

Similarly to this, also when the accumulation necessary replenishment time Tz[M] of the magenta toner becomes equal to or greater than the toner replenishment threshold Ta, the magenta replenishment member 106[M] is driven, that is, replenishment of the magenta toner is performed. This replenishment of the magenta toner is performed for the accumulation necessary replenishment time Tz[M] with the continuous replenishment allowable time Ton as an upper limit. In particular, when the accumulation necessary replenishment time Tz[M] exceeds the continuous replenishment allowable time Ton, replenishment of the magenta toner is intermittently performed in a pattern in accordance with the above-described replenishment duty on condition that the accumulation necessary replenishment time Tz[Y] of the yellow toner, which is the other toner, is less than the toner replenishment threshold Ta.

When both the accumulation necessary replenishment time Tz[Y] of the yellow toner and the accumulation necessary replenishment time Tz[M] of the magenta toner become equal to or greater than the toner replenishment threshold Ta, first, the toner replenishment related to the longer one of the accumulation necessary replenishment time Tz[Y] of the yellow toner and the accumulation necessary replenishment time Tz[M] of the magenta toner (i.e., the one having a high necessity of replenishment) is preferentially performed. That is, similarly to that described above, the replenishment of one toner α is performed for the accumulation necessary replenishment time Tz[a] (a; index representing Y or M) of the one toner α with the continuous replenishment allowable time Ton as an upper limit. In other words, the replenishment of the one toner α is performed for the accumulation necessary replenishment time Tz[a] or the continuous replenishment allowable time Ton. Thereafter, replenishment of another toner β is performed. This replenishment of the other toner β is also performed for the accumulation necessary replenishment time Tz[β] (B; index representing M or Y) of the other toner β with the continuous replenishment allowable time Ton as an upper limit. Thereafter, according to the current accumulation necessary replenishment time Tz[a] of the one toner α and the current accumulation necessary replenishment time Tz[β] of the other toner β, the replenishment of the one toner α is resumed, the replenishment of the other toner β is resumed, or both the replenishment of the one toner α and the replenishment of the other toner β are brought into a stop state.

That is, according to the present first example, when at least one of the accumulation necessary replenishment time Tz[Y] of the yellow toner and the accumulation necessary replenishment time Tz[M] of the magenta toner becomes equal to or greater than the toner replenishment threshold Ta, replenishment of the one toner α related to the accumulation necessary replenishment time Tz[Y] of the yellow toner or the accumulation necessary replenishment time Tz[M] of the magenta toner that becomes equal to or greater than the toner replenishment threshold Ta is performed. This replenishment of the one toner α is performed for the accumulation necessary replenishment time Tz[a] of the one toner α with the continuous replenishment allowable time Ton as an upper limit. Thereafter, according to the accumulation necessary replenishment time Tz[β] of the other toner β and the current accumulation necessary replenishment time Tz[a] of the one toner α, the replenishment of the other toner β is performed, the replenishment of the one toner α is resumed, or the replenishment of both of these toners is brought into a stop state. In particular, when the replenishment of the other toner β is performed, the replenishment of the other toner β is performed for the accumulation necessary replenishment time Tz[β] of the other toner β with the continuous replenishment allowable time Ton as the upper limit. When the replenishment of the one toner α is resumed, after the predetermined replenishment stop time Toff has elapsed, the replenishment of the one toner α is resumed for the current accumulation necessary replenishment time Tz[a] of the one toner α with the continuous replenishment allowable time Ton as an upper limit. When the accumulation necessary replenishment time Tz[β] of the other toner β is equal to or less than the toner replenishment threshold Ta and the current accumulation necessary replenishment time Tz[a] of the one toner α is also equal to or less than the toner replenishment threshold Ta, the replenishment of both of the toners a and β is brought into a stop state.

The toner replenishment threshold Ta has an appropriate value, for example, 1 s, so that toner replenishment is not frequently performed, in other words, the toner replenishment is performed at a necessary and sufficient frequency. The continuous replenishment allowable time Ton preferably has a value equal to or greater than the necessary replenishment time Ts[X] when the printing rate Rp[X] is 50% and equal to or less than the necessary replenishment time Ts[X] when the printing rate Rp[X] is 90%, more preferably has a value equal to or greater than the necessary replenishment time Ts[X] when the printing rate Rp[X] is 75% and equal to or less than the necessary replenishment time Ts[X] when the printing rate Rp[X] is 85%, for example, 1 s. The continuous replenishment allowable time Ton of 1 s corresponds to the necessary replenishment time Ts[X] when the printing rate Rp[X] is about 77%. The replenishment stop time Toff has a value of about 1/20 to ⅕ of the continuous replenishment allowable time Ton, for example, 0.1 s corresponding to a value of 1/10 of the continuous replenishment allowable time Ton. Specific values of the toner replenishment threshold Ta, the continuous replenishment allowable time Ton, and the replenishment stop time Toff are merely examples, and are not limited to these values.

Furthermore, when both the accumulation necessary replenishment time Tz[Y] of the yellow toner and the accumulation necessary replenishment time Tz[M] of the magenta toner become equal to or greater than the toner replenishment threshold Ta, and when the accumulation necessary replenishment time Tz[Y] of the yellow toner and the accumulation necessary replenishment time Tz[M] of the magenta toner have the same length as each other, a toner density detection value T/D[Y] by the toner density sensor 50b of the development apparatus 50 for yellow and a toner density detection value T/D[M] by the toner density sensor 50b of the development apparatus 50 for magenta are compared with each other. The toner replenishment related to the smaller value (one with a lower toner density T/D) of the toner density detection value T/D[Y] of the yellow toner and the toner density detection value T/D[M] of the magenta toner is preferentially performed. Thereafter, the same applies to a case where both the accumulation necessary replenishment time Tz[Y] of the yellow toner and the accumulation necessary replenishment time Tz[M] of the magenta toner become equal to or greater than the toner replenishment threshold Ta, and where first, the toner replenishment related to the longer one of the accumulation necessary replenishment time Tz[Y] of the yellow toner and the accumulation necessary replenishment time Tz[M] of the magenta toner is preferentially performed.

When both the accumulation necessary replenishment time Tz[Y] of the yellow toner and the accumulation necessary replenishment time Tz[M] of the magenta toner become equal to or greater than the toner replenishment threshold Ta, and when the accumulation necessary replenishment time Tz[Y] of the yellow toner and the accumulation necessary replenishment time Tz[M] of the magenta toner have the same length as each other, and the toner density detection value T/D[Y] of the yellow toner and the toner density detection value T/D[M] of the magenta toner have the same value as each other, the replenishment of the toner on a predetermined side, for example, the replenishment of the yellow toner is preferentially performed. Thereafter, the same applies to a case where both the accumulation necessary replenishment time Tz[Y] of the yellow toner and the accumulation necessary replenishment time Tz[M] of the magenta toner become equal to or greater than the toner replenishment threshold Ta, and where first, the toner replenishment related to the longer one of the accumulation necessary replenishment time Tz[Y] of the yellow toner and the accumulation necessary replenishment time Tz[M] of the magenta toner is preferentially performed. Not the replenishment of the yellow toner but the replenishment of the magenta toner may be preferentially performed.

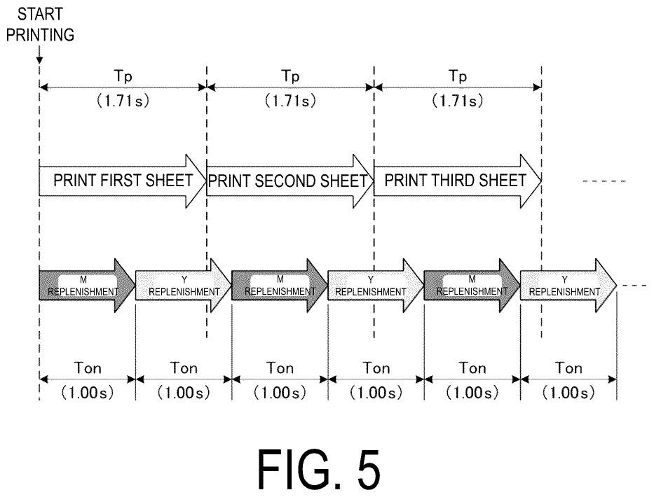

Here, for example, assume a case where printing in which the printing rate Rp[Y] of yellow is 100% and the printing rate Rp[M] of magenta is 100% is continuously performed. In this case, as illustrated in FIG. 5, printing on one sheet of paper is repeatedly performed at a cycle of the printing time Tp being 1.71 s. On the other hand, the replenishment of the yellow toner and the replenishment of the magenta toner are alternately performed at a cycle of the continuous replenishment allowable time Ton being 1 s, so to speak, performed totally asynchronously with the printing. As described above, the continuous replenishment allowable time Ton of 1 s corresponds to the necessary replenishment time Ts[X] in a case where the printing rate Rp[X] is about 77%, and the replenishment of the yellow toner and the replenishment of the magenta toner are alternately performed at a cycle of such the continuous replenishment allowable time Ton, whereby the replenishment of the yellow toner and the replenishment of the magenta toner are performed in an extremely good (perfect) balance. Thus, the balance between the toner density T/D[Y] in the developer accommodation chamber 50a of the development apparatus 50 for yellow and the toner density T/D[M] in the developer accommodation chamber 50a of the development apparatus 50 for magenta is well kept, and furthermore, a good density balance is also kept on an image (output image) finally formed on a sheet. FIG. 5 illustrates an example in which replenishment of the magenta toner is preferentially performed.

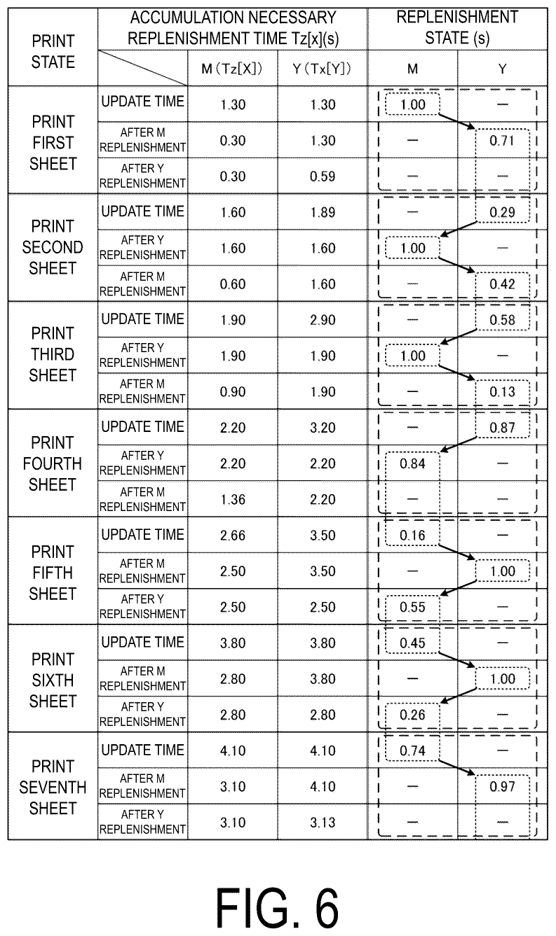

The replenishment manner of the yellow toner and the magenta toner illustrated in FIG. 5 will be described with reference to FIG. 6 in relation to the respective accumulation necessary replenishment times Tz[X] (Tz[Y] and Tz[M]). FIG. 6 illustrates an example in which the accumulation necessary replenishment time Tz[Y] of the yellow toner immediately before a job instructing execution of printing is received is 0 s, the accumulation necessary replenishment time Tz[M] of the magenta toner is also 0 s, and the replenishment of the magenta toner is preferentially performed.

As illustrated in FIG. 6, when printing of the first sheet is performed, the accumulation necessary replenishment time Tz[M] of the magenta toner is 1.3 s, and the accumulation necessary replenishment time Tz[Y] of the yellow toner is also 1.3 s. More specifically, the printing rate Rp[M] of magenta and the printing rate Rp[Y] of yellow are derived based on the image data (pixel data) used for printing of the first sheet. The necessary replenishment time Ts[M] of the magenta toner is derived based on the printing rate Rp[M] of magenta, and the necessary replenishment time Ts[Y] of the yellow toner is derived based on the printing rate Rp[Y] of yellow. The accumulation necessary replenishment time Tz[M] of the magenta toner is updated by the necessary replenishment time Ts[M] of the magenta toner that is derived, and the accumulation necessary replenishment time Tz[Y] of the yellow toner is updated by the necessary replenishment time Ts[Y] of the yellow toner that is derived. As a result, the accumulation necessary replenishment time Tz[M] of the magenta toner has a value of 1.3 s in which the necessary replenishment time Ts[M] of the magenta toner of 1.3 s according to the printing rate Rp[M] of magenta of 100% is added to the value of 0 s before the update. The accumulation necessary replenishment time Tz[Y] of the yellow toner has a value of 1.3 s in which the necessary replenishment time Ts[Y] of the yellow toner of 1.3 s corresponding to the printing rate Rp[Y] of yellow of 100% is added to the value of 0 s before the update.

Since both the accumulation necessary replenishment time Tz[M] (=1.3 s) of the magenta toner and the accumulation necessary replenishment time Tz[Y] (=1.3 s) of the yellow toner updated in this manner are equal to or greater than the toner replenishment threshold Ta (=1 s), first, the replenishment of one of the magenta toner and the yellow toner is performed, and here, the replenishment of the magenta toner is preferentially performed as described above. This replenishment of the magenta toner is performed for the accumulation necessary replenishment time Tz[M] of the magenta toner with the continuous replenishment allowable time Ton (=1 s) as an upper limit, that is, for the continuous replenishment allowable time Ton of 1 s. Accordingly, the accumulation necessary replenishment time Tz[M] of the magenta toner becomes 0.3 s (=1.3 s−1 s). On the other hand, the accumulation necessary replenishment time Tz[Y] of the yellow toner, which is 1.3 s, remains unchanged.

After this replenishment of the magenta toner is performed, the replenishment of the yellow toner which is the other toner is performed. This replenishment of the yellow toner is performed for the accumulation necessary replenishment time Tz[Y] of the yellow toner with the continuous replenishment allowable time Ton as an upper limit, that is, for the continuous replenishment allowable time Ton of 1 s. On the other hand, while the replenishment of the yellow toner is being performed, the printing of the first sheet is finished, and the printing of the second sheet is performed. That is, the printing of the first sheet is performed until a time of 0.71 s (=Tp-1 s) elapses from the start of the replenishment of the yellow toner, and the printing of the second sheet is performed after the time of 0.71 s elapses. Therefore, the accumulation necessary replenishment time Tz[Y] of the yellow toner at the time point when the printing of the first sheet is finished is 0.59 s (=1.30 s−0.71 s). The accumulation necessary replenishment time Tz[M] of the magenta toner at the time point when the printing of the first sheet is finished, which is 0.3 s, remains unchanged.

When printing of the second sheet is performed, the accumulation necessary replenishment time Tz[M] of the magenta toner is updated to 1.6 s (=0.3 s+1.3 s), and the accumulation necessary replenishment time Tz[Y] of the yellow toner is updated to 1.89 s (=0.59 s+1.3 s). At this time, the replenishment of the yellow toner is in a state of being continuously performed. Then, at a time point when a time of 0.29 s (=1 s−0.71 s) has elapsed from the start of printing of the second sheet, the replenishment of the yellow toner for a time of 1 s is finished. The accumulation necessary replenishment time Tz[Y] of the yellow toner at this time point is 1.6 s (=1.89 s−0.29 s), and the accumulation necessary replenishment time Tz[Y] of the magenta toner, which is 1.6 s, remains unchanged.

That is, since the accumulation necessary replenishment time Tz[Y] (=1.6 s) of the magenta toner at the time point when the replenishment of the yellow toner for the time of 1 s is finished is equal to or greater than the toner replenishment threshold Ta (=1 s), the replenishment of the magenta toner is resumed. This replenishment of the magenta toner is performed for the accumulation necessary replenishment time Tz[M] of the magenta toner with the continuous replenishment allowable time Ton (=1 s) as an upper limit, that is, performed for the continuous replenishment allowable time Ton of 1 s. Accordingly, the accumulation necessary replenishment time Tz[M] of the magenta toner becomes 0.6 s (=1.6 s−1 s). On the other hand, the accumulation necessary replenishment time Tz[Y] of the yellow toner, which is 1.6 s, remains unchanged.

Since the accumulation necessary replenishment time Ts[Y] (=1.6 s) of the yellow toner at the time point when this replenishment of the magenta toner is finished is equal to or greater than the toner replenishment threshold Ta (=1 s), the replenishment of the yellow toner is resumed. Thereafter, the replenishment of the magenta toner and the replenishment of the yellow toner are alternately performed in a similar manner.

When the accumulation necessary replenishment time Tz[M] of the magenta toner and the accumulation necessary replenishment time Tz[Y] of the yellow toner in this process are compared, the mutual difference between them (=|Tz[M]-Tz[Y] |) is 1 s at the maximum. The mutual difference (time) of 1 s is equivalent to 0.2 g when converted into the amount of toner, and is extremely small. This means that the replenishment of the magenta toner and the replenishment of the yellow toner are performed in a very good balance, and a good density balance is kept also on the output image.

In FIG. 6, the total time surrounded by the short broken line is 1 s, that is, the continuous replenishment allowable time Ton. In FIG. 6, the total time surrounded by the long broken line is 1.71 s, that is, the printing time Tp per sheet of paper. That is, after one of the replenishment of the magenta toner and the replenishment of the yellow toner is performed for the continuous replenishment allowable time Ton, the other of the replenishment of the magenta toner and the replenishment of the yellow toner is performed for the continuous replenishment allowable time Ton, that is, the replenishment target transitions (switches) as indicated by the arrow in FIG. 6. This transition of the replenishment target is performed asynchronously with the print state.

Here, the first replenishment apparatus 37a, that is, the selective replenishment manner of the yellow toner and the magenta toner has been described, but also the second replenishment apparatus 37b, that is, selective replenishment is performed in a similar manner also for the cyan toner and the black toner. That is, the selective replenishment is performed in an extremely good balance also for the cyan toner and the black toner, and a good density balance is kept also on the output image.

As seen from FIG. 6, each time printing in which the printing rate Rp[Y] of yellow is 100% and the printing rate Rp[M] of magenta is 100% is performed, each of the accumulation necessary replenishment time Tz[Y] of the yellow toner and the accumulation necessary replenishment time Tz[M] of the magenta toner increases. When each of the accumulation necessary replenishment time Tz[Y] of the yellow toner and the accumulation necessary replenishment time Tz[M] of the magenta toner excessively increases, each of the replenishment of the yellow toner and the replenishment of the magenta toner is excessively not in time, and each of the amount of the yellow toner and the amount of the magenta toner to be used for development is insufficient. As a result, an image quality defect of density reduction occurs in the output image.

In order to avoid this, when the accumulation necessary replenishment time Tz[X] of the toner of any color becomes equal to or greater than a forced replenishment threshold Tb as the predetermined third threshold, the printing is interrupted, and forced replenishment of performing replenishment for the accumulation necessary replenishment time Tz[X] for the toner of all colors, respectively. However, when the forced replenishment is frequently performed, printing is interrupted accordingly, and thus productivity is reduced. Therefore, it is important that the forced replenishment threshold Tb which is a criterion for determining whether to perform forced replenishment is appropriately determined. The forced replenishment threshold Tb in the present first example is, for example, 5 s. The specific value of this forced replenishment threshold Tb is an example, and is not limited thereto, but it is assumed that the forced replenishment threshold Tb is a value larger than the toner replenishment threshold Ta and the continuous replenishment allowable time Ton described above.

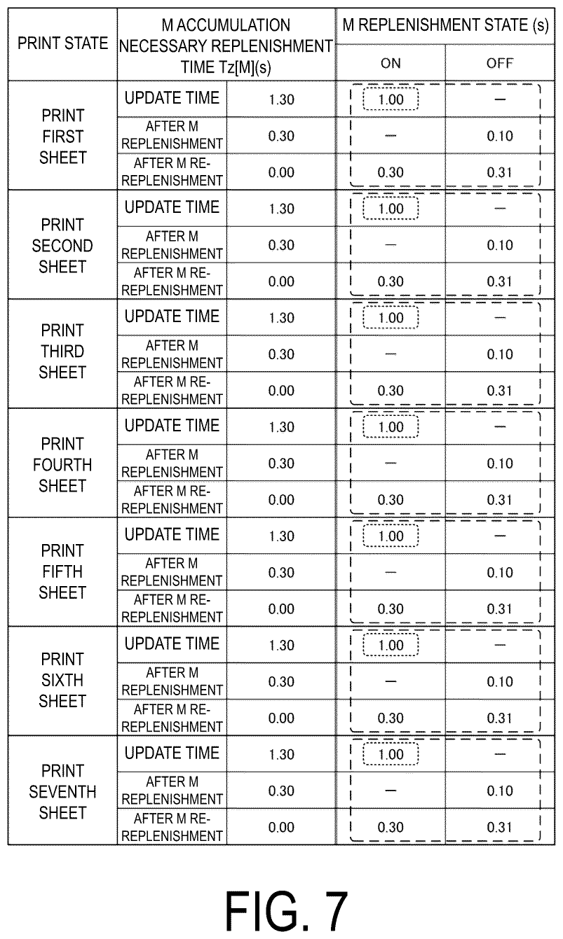

Furthermore, a case of continuously performing printing in which the printing rate Rp[Y] of yellow is 0% and the printing rate Rp[M] of magenta is 100% will be described with reference to FIG. 7. FIG. 7 illustrates an example in which the accumulation necessary replenishment time Tz[M] of the magenta toner immediately before a job instructing execution of printing is received is 0 s, and the accumulation necessary replenishment time Tz[Y] of the yellow toner is less than the toner replenishment threshold Ta.

As illustrated in FIG. 7, when printing of the first sheet is performed, the accumulation necessary replenishment time Tz[M] of the magenta toner becomes 1.3 s. Then, replenishment of the magenta toner is performed. This replenishment of the magenta toner is performed for the accumulation necessary replenishment time Tz[M] of the magenta toner with the continuous replenishment allowable time Ton (=1 s) as an upper limit, that is, for the continuous replenishment allowable time Ton of 1 s. Accordingly, the accumulation necessary replenishment time Tz[M] of the magenta toner becomes 0.3 s (=1.3 s−1 s). On the other hand, although not illustrated, the accumulation necessary replenishment time Tz[Y] of the yellow toner remains less than the toner replenishment threshold Ta as described above.

After the replenishment of the magenta toner is stopped for the replenishment stop time Toff (=0.1 s), the replenishment of the magenta toner is resumed. This replenishment of the magenta toner is performed until the accumulation necessary replenishment time Tz[M] of the magenta toner becomes 0, that is, performed for 0.3 s. Thereafter, the replenishment of the magenta toner is stopped until the printing of the second sheet is started, that is, until a time of 0.31 s (=1.71 s−1 s−0.1 s−0.3 s) elapses (this stop time of 0.1 s is provided when the accumulation necessary replenishment time Tz[Y] of the partner yellow toner is less than the toner replenishment threshold Ta, that is, when it is not necessary to switch the rotation direction of the first replenishment motor 110a from the other direction R2 to the one direction R1. In this way, the determination processing of a control program of the first replenishment motor 110a can be simplified).

When printing of the second sheet is performed, the accumulation necessary replenishment time Tz[M] of the magenta toner becomes 1.3 s again. Thereafter, replenishment of the magenta toner is performed in a similar manner.

As seen from FIG. 7, in a case of continuously performing printing in which the printing rate Rp[Y] of yellow is 0% and the printing rate Rp[M] of magenta is 100%, the accumulation necessary replenishment time Tz[M] of the magenta toner does not become greater than 1.3 s, that is, does not excessively increase. Therefore, the above-described forced replenishment is not performed, and productivity is kept.

In FIG. 7, the time surrounded by the short broken line is a replenishment time per one time of the magenta toner, that is, the continuous replenishment allowable time Ton (=1 s). In FIG. 7, the total time surrounded by the long broken line is 1.71 s, that is, the printing time Tp per sheet of paper.

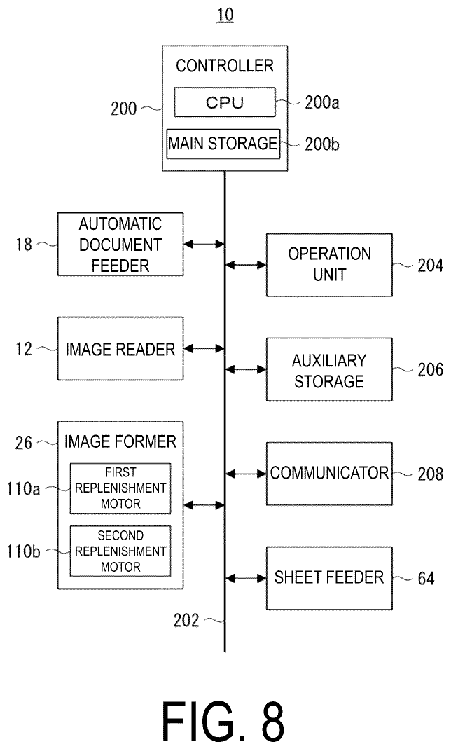

FIG. 8 is a block diagram illustrating an electrical configuration of the image forming apparatus 10. As illustrated in FIG. 8, the image forming apparatus 10 includes a controller 200. The image reader 12, the automatic document feeder 18, the image former 26, and the sheet feeder 64 are connected to the controller 200 via a bus 202. In addition, an operation unit 204, an auxiliary storage 206, a communicator 208, and the like are connected to the controller 200 via the bus 202. The image forming apparatus 10 includes various elements other than them. However, illustration and description of elements not directly related to the gist of the present disclosure are omitted here. The image reader 12, the automatic document feeder 18, the image former 26, and the sheet feeder 64 are configured as described above. In particular, the image former 26 includes the first replenishment motor 110a and the second replenishment motor 110b.

The controller 200 is a controller that controls the entire image forming apparatus 10. Therefore, the controller 200 includes a computer as a control execution means, for example, a CPU 200a. In addition, the controller 200 includes a main storage 200b as a main storage that can be directly accessed by the CPU 200a. The main storage 200b includes, for example, a ROM and a RAM not illustrated. The ROM stores a control program (firmware) that controls the operation of the CPU 200a. This control program includes a toner replenishment control program described later. The RAM constitutes a work area and a buffer area when the CPU 200a executes processing according to the control program.

The operation unit 204 has a display with a touchscreen not illustrated. The display with a touchscreen is a component integrally combining a touchscreen as an example of an operation receptor that can receive an operation by a user not illustrated and a display as an example of a display that displays various types of information. The operation unit 204 includes an appropriate light emitter such as an LED not illustrated and an appropriate hardware switch such as a push button not illustrated, in addition to the display with a touchscreen.

The auxiliary storage 206 is an example of an auxiliary storage. That is, the auxiliary storage 206 appropriately stores various data such as the read image data and the job described above. This auxiliary storage 206 includes, for example, a hard disk drive not illustrated. In addition, the auxiliary storage 206 may include a rewritable nonvolatile memory such as a flash memory.

The communicator 208 is an example of a communicator. That is, the communicator 208 performs bidirectional communication processing via a LAN line not illustrated. The communicator 208 may be connected to the LAN line by wire or wirelessly. The communicator 208 also performs bidirectional communication processing via a public switched telephone network not illustrated.

As described above, according to the present first example, in particular, according to the first replenishment apparatus 37a, when at least one of the accumulation necessary replenishment time Tz[Y] of the yellow toner and the accumulation necessary replenishment time Tz[M] of the magenta toner becomes equal to or greater than the toner replenishment threshold Ta, replenishment of the one toner α related to the accumulation necessary replenishment time Tz[Y] of the yellow toner or the accumulation necessary replenishment time Tz[M] of the magenta toner that becomes equal to or greater than the toner replenishment threshold Ta is performed. This replenishment of the one toner α is performed for the accumulation necessary replenishment time Tz[a] of the one toner α with the continuous replenishment allowable time Ton as an upper limit. Thereafter, according to the accumulation necessary replenishment time Tz[β] of the other toner β and the current accumulation necessary replenishment time Tz[a] of the one toner α, the replenishment of the other toner β is performed, the replenishment of the one toner α is resumed, or the replenishment of both the toners a and β is brought into a stop state. The toner replenishment is performed in a similar manner also in the second replenishment apparatus 37b.

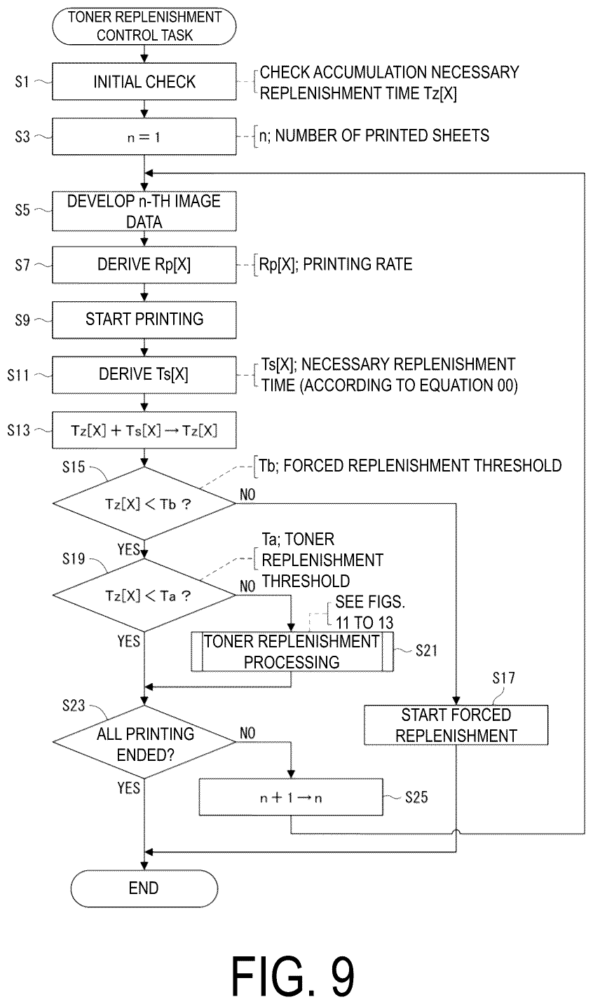

In order to implement toner replenishment in such a manner, the CPU 200a executes a toner replenishment control task according to the above-described toner replenishment control program. FIG. 9 shows the flow of this toner replenishment control task. The toner replenishment control task is executed in response to reception of a job instructing execution of printing. The job mentioned here includes jobs in the printer function, the copy function, and the fax function (fax reception function).

According to this toner replenishment control task, the CPU 200a first performs initial check in step S1. In this initial check, with reference to history information of the previous job, the CPU 200a checks the accumulation necessary replenishment time Tz[X] of each toner at the present time point (at the start time point of the toner replenishment control task). The history information of job is stored in, for example, the auxiliary storage 206. The CPU 200a advances the processing to step S3.

In step S3, the CPU 200a sets a variable n representing the number of printed sheets to a value of 1 which is an initial value of the variable n. In subsequent step S5, the CPU 200a develops (analyzes) image data to be used for printing the nth sheet. Furthermore, in subsequent step S7, the CPU 200a derives the printing rate Rx [X] related to each toner based on the image data developed in step S5. In subsequent step S9, the CPU 200a starts printing of the nth sheet, and then advances the processing to step S11. The printing started in step S9 is performed by a print task different from the toner replenishment control task. Detailed description of this print task including illustration thereof will be omitted.

In step S11, the CPU 200a derives the necessary replenishment time Ts[X] (=Qc[X]/Vs[X]) for each toner. In this deriving of the necessary replenishment time Ts[X], the consumption amount Qc[X] of each toner is used, and this consumption amount Qc[X] is obtained based on a relational expression between the printing rate Rp[X] and the consumption amount Qc[X] related to each toner, for example. Alternatively, the consumption amount Qc[X] may be obtained based on a lookup table in which the relationship between the printing rate Rp[X] and the consumption amount Qc[X] related to each toner is summarized. After the execution of step S11, the CPU 200a advances the processing to step S13.

In step S13, the CPU 200a adds the necessary replenishment time Ts[X] of each toner derived in step S11 to the accumulation necessary replenishment time Tz[X] of each toner at the present time point, and sets the added value as a new accumulation necessary replenishment time Tz[X], that is, updates the accumulation necessary replenishment time Tz[X]. The CPU 200a advances the processing to step S15.

In step S15, the CPU 200a compares the accumulation necessary replenishment time Tz[X] of each toner with the forced replenishment threshold Tb, and determines whether the accumulation necessary replenishment time Tz[X] of each toner is less than the forced replenishment threshold Tb. Here, if the accumulation necessary replenishment time Tz[X] of any toner is equal to or greater than the forced replenishment threshold Tb (S15: NO), the CPU 200a advances the processing to step S17. On the other hand, if the accumulation necessary replenishment time Tz[X] of all the toners is less than the forced replenishment threshold Tb (S15: YES), the CPU 200a advances the processing to step S19 described later.

In step S17, the CPU 200a starts the above-described forced replenishment and ends the toner replenishment control task. The forced replenishment is performed by a forced replenishment task different from the toner replenishment control task. Detailed description of this forced replenishment task including illustration thereof will be omitted. When the forced replenishment is started, printing is interrupted. When the forced replenishment ends, printing is resumed.

On the other hand, when advancing the processing from step S15 to step S19, the CPU 200a compares the accumulation necessary replenishment time Tz[X] of each toner with the toner replenishment threshold Ta in step S19, and determines whether the accumulation necessary replenishment time Tz[X] of each toner is less than the toner replenishment threshold Ta. Here, if the accumulation necessary replenishment time Tz[X] of any toner is equal to or greater than the toner replenishment threshold Ta (S19: NO), the CPU 200a advances the processing to step S21. On the other hand, if the accumulation necessary replenishment time Tz[X] of all the toners is less than the toner replenishment threshold Ta (S19: YES), the CPU 200a advances the processing to step S23 described later.

In step S21, the CPU 200a executes toner replenishment processing that performs toner replenishment. This toner replenishment processing will be described in detail later. After finishing this toner replenishment processing, the CPU 200a advances the processing to step S23.

In step S23, the CPU 200a determines whether all the printing according to the job is finished. Here, if all the printing according to the job is finished (S23: YES), the CPU 200a ends the toner replenishment control task. On the other hand, if all the printing according to the job is not finished yet, the CPU 200a advances the processing to step S25. In step S25, the CPU 200a increments the value of the variable n representing the number of printed sheets, and then returns the processing to step S5.

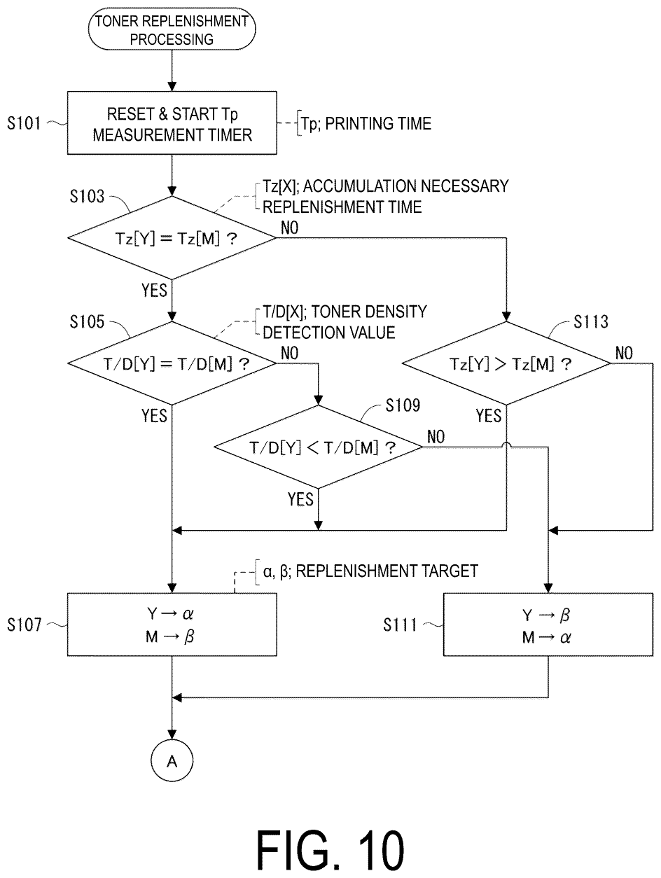

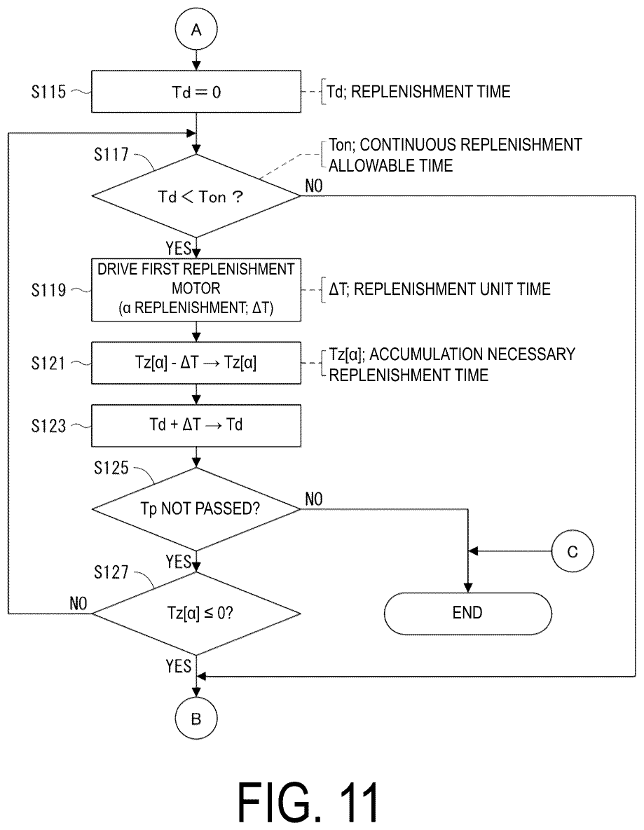

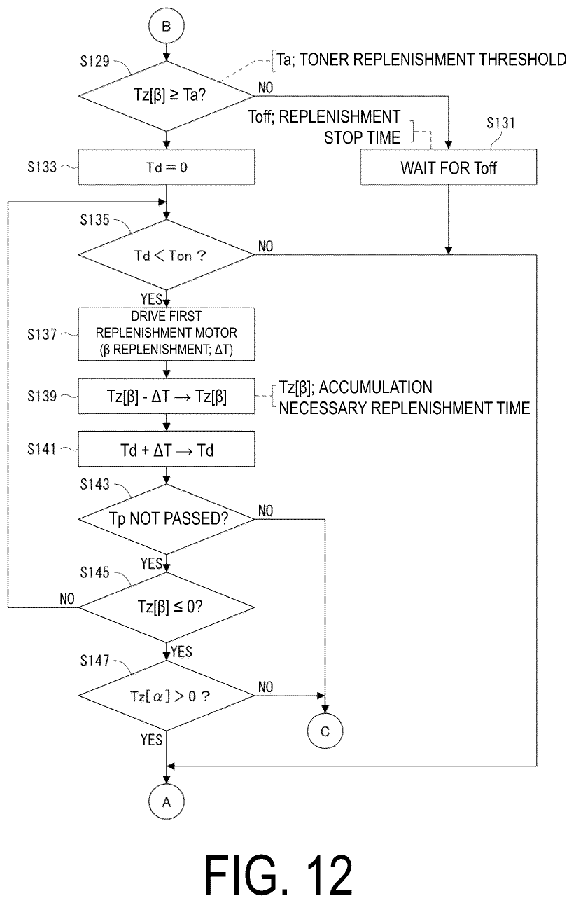

Next, the toner replenishment processing will be described with reference to FIGS. 10 to 12. Note that FIGS. 10 to 12 illustrate the flow of the toner replenishment processing for the first replenishment apparatus 37a, but the toner replenishment processing is also performed for the second replenishment apparatus 37b in the same flow.

According to this toner replenishment processing, first, in step S101, the CPU 200a resets and starts a timer not illustrated that measures the printing time Tp (strictly speaking, the printing time Tp in which the processing time of the toner replenishment control task including the toner replenishment processing is taken into consideration (subtracted)) per sheet. This timer is a software timer configured by the CPU 200a, for example, but may be a hardware timer configured by a hardware element such as a real-time clock (RTC). After the execution of this step S101, the CPU 200a advances the processing to step S103.

In step S103, the CPU 200a compares the accumulation necessary replenishment time Tz[Y] of the yellow toner with the accumulation necessary replenishment time Tz[M] of the magenta toner, and determines whether both are equivalent to each other. Here, if both are equivalent to each other (S103: YES), the CPU 200a advances the processing to step S105. On the other hand, if both are not equivalent to each other (S103: NO), the CPU 200a advances the processing to step S113 described later.

In step S105, the CPU 200a compares the toner density detection value T/D[Y] of the yellow toner with the toner density detection value T/D[M] of the magenta toner, and determines whether both are equivalent to each other. Here, if both are equivalent to each other (S105: YES), the CPU 200a advances the processing to step S107. On the other hand, if both are not equivalent to each other (S105: NO), the CPU 200a advances the processing to step S109 described later.

In step S107, the CPU 200a specifies the yellow toner as the replenishment target α, that is, the yellow toner as the one toner α described above. In addition, the CPU 200a specifies the magenta toner as the replenishment target β, that is, the magenta toner as the other toner β described above. The CPU 200a advances the processing to step S115 described later.

On the other hand, when advancing the processing from step S105 to step S109 described above, the CPU 200a determines whether the toner density detection value T/D[Y] of the yellow toner is less than the toner density detection value T/D[M] of the magenta toner in step S109. Here, if the toner density detection value T/D[Y] of the yellow toner is less than the toner density detection value T/D[M] of the magenta toner (S109: YES), the CPU 200a advances the processing to step S107. On the other hand, if the toner density detection value T/D[Y] of the yellow toner is larger than the toner density detection value T/D[M] of the magenta toner (S109: NO), the CPU 200a advances the processing to step S111 described later.

In step S111, the CPU 200a specifies the yellow toner as the replenishment target β, that is, the yellow toner as the other toner β. In addition, the CPU 200a specifies the magenta toner as the replenishment target α, that is, specifies the magenta toner as the one toner α. The CPU 200a advances the processing to step S115 described later.

Furthermore, when advancing the processing from step S103 to step S113 described above, the CPU 200a determines whether the accumulation necessary replenishment time Tz[Y] of the yellow toner is longer than the accumulation necessary replenishment time Tz[M] of the magenta toner in step S113. Here, if the accumulation necessary replenishment time Tz[Y] of the yellow toner is longer than the accumulation necessary replenishment time Tz[M] of the magenta toner (S113: YES), the CPU 200a advances the processing to step S107. On the other hand, if the accumulation necessary replenishment time Tz[Y] of the yellow toner is shorter than the accumulation necessary replenishment time Tz[M] of the magenta toner (S113: NO), the CPU 200a advances the processing to step S111.

In step S115, the CPU 200a resets a counter that counts the replenishment time Td of the toner being replenishment target, that is, sets the count value to 0 as an initial value. The CPU 200a advances the processing to step S117.

In step S117, the CPU 200a compares the count value of the counter that counts the replenishment time Td with the continuous replenishment allowable time Ton, and determines whether the replenishment time Td is less than the continuous replenishment allowable time Ton. Here, if the replenishment time Td is less than the continuous replenishment allowable time Ton (S117: YES), the CPU 200a advances the processing to step S119. On the other hand, if the replenishment time Td is equal to or greater than the continuous replenishment allowable time Ton (S117: NO), the CPU 200a advances the processing to step S129 described later.

In step S119, the CPU 200a drives the first replenishment motor 110a so that replenishment of the one toner α is performed for a predetermined replenishment unit time ΔT. The replenishment unit time ΔT mentioned here is a time sufficiently shorter than the continuous replenishment allowable time Ton (=1 s), and is, for example, 0.1 s. After the execution of step S119, the CPU 200a advances the processing to step S121.

In step S121, the CPU 200a subtracts the replenishment unit time ΔT from the current accumulation necessary replenishment time Tz[a] of the one toner α, and sets the subtracted value as a new accumulation necessary replenishment time Tz[a], that is, updates the accumulation necessary replenishment time Tz[a]. The CPU 200a advances the processing to step S123.

In step S123, the CPU 200a subtracts the replenishment unit time ΔT from the count value of the counter that counts the replenishment time Td described above, and sets the subtracted value as a new count value, that is, updates the count value of the replenishment time Td. The CPU 200a advances the processing to step S125.

In step S125, the CPU 200a determines whether the measurement time by the timer described above has not yet passed the printing time Tp per sheet, that is, whether the printing time Tp has not yet elapsed. Here, if the printing time Tp has not yet elapsed (S125: YES), the CPU 200a advances the processing to step S127. On the other hand, if the printing time Tp has elapsed (S125: NO), the CPU 200a ends the toner replenishment processing.

In step S127, the CPU 200a determines whether the current accumulation necessary replenishment time Tz[a] of the one toner α is 0 or less. Here, if the current accumulation necessary replenishment time Tz[a] of the one toner α is not 0 or less (S127: NO), the CPU 200a returns the processing to step S117. On the other hand, if the current accumulation necessary replenishment time Tz[a] of the one toner α is 0 or less (S127: YES), the CPU 200a advances the processing to step S129.

In step S129, the CPU 200a compares the accumulation necessary replenishment time Tz[β] of the other toner β with the toner replenishment threshold Ta, and determines whether the accumulation necessary replenishment time Tz[β] is equal to or greater than the toner replenishment threshold Ta. Here, if the accumulation necessary replenishment time Tz[β] is less than the toner replenishment threshold Ta (S129: NO), the CPU 200a advances the processing to step S131. In step S131, the CPU 200a waits for the replenishment stop time Toff, and then returns the processing to step S115. On the other hand, in step S129, if the accumulation necessary replenishment time Tz[β] is equal to or greater than the toner replenishment threshold Ta (S129: YES), the CPU 200a advances the processing to step S133.

In step S133, the CPU 200a resets the above-described counter that counts the replenishment time Td of the toner being replenishment target, and then advances the processing to step S135. In step S135, the CPU 200a compares the count value of the replenishment time Td by the counter with the continuous replenishment allowable time Ton, and determines whether the replenishment time Td is less than the continuous replenishment allowable time Ton. Here, if the replenishment time Td is equal to or greater than the continuous replenishment allowable time Ton (S135: NO), the CPU 200a returns the processing to step S115. On the other hand, if the replenishment time Td is less than the continuous replenishment allowable time Ton (S135: YES), the CPU 200a advances the processing to step S137.

In step S137, the CPU 200a drives the first replenishment motor 110a so that the replenishment of the other toner β is performed for the above-described replenishment unit time ΔT. Thereafter, the CPU 200a advances the processing to step S139.

In step S139, the CPU 200a subtracts the replenishment unit time ΔT from the current accumulation necessary replenishment time Tz[β] of the other toner, and sets the subtracted value as a new accumulation necessary replenishment time Tz[β], that is, updates the accumulation necessary replenishment time Tz[β]. The CPU 200a advances the processing to step S141.

In step S141, the CPU 200a subtracts the replenishment unit time ΔT from the count value of the replenishment time Td by the counter described above, and sets the subtracted value as a new count value, that is, updates the count value of the replenishment time Td. The CPU 200a advances the processing to step S143.

In step S143, the CPU 200a determines whether the measurement time by the timer described above has not yet passed the printing time Tp per sheet, that is, whether the printing time Tp has not yet elapsed. Here, if the printing time Tp has not yet elapsed (S143: YES), the CPU 200a advances the processing to step S145. On the other hand, if the printing time Tp has elapsed (S143: NO), the CPU 200a ends the toner replenishment processing.

In step S145, the CPU 200a determines whether the current accumulation necessary replenishment time Tz[β] of the other toner β is 0 or less. Here, if the current accumulation necessary replenishment time Tz[β] of the other toner β is not 0 or less (S145: NO), the CPU 200a returns the processing to step S135. On the other hand, if the current accumulation necessary replenishment time Tz[β] of the other toner β is 0 or less (S147: YES), the CPU 200a returns the processing to step S115.

Thus, according to the present first example, in particular, according to the first replenishment apparatus 37a, when at least one of the accumulation necessary replenishment time Tz[Y] of the yellow toner and the accumulation necessary replenishment time Tz[M] of the magenta toner becomes equal to or greater than the toner replenishment threshold Ta, replenishment of the one toner α related to the accumulation necessary replenishment time Tz[Y] of the yellow toner or the accumulation necessary replenishment time Tz[M] of the magenta toner that becomes equal to or greater than the toner replenishment threshold Ta is performed. This replenishment of the one toner α is performed for the accumulation necessary replenishment time Tz[a] of the one toner α with the continuous replenishment allowable time Ton as an upper limit. Thereafter, according to the accumulation necessary replenishment time Tz[β] of the other toner β and the current accumulation necessary replenishment time Tz[a] of the one toner α, the replenishment of the other toner β is performed, the replenishment of the one toner α is resumed, or the replenishment of both the toners a and β is brought into a stop state. The toner replenishment is performed in a similar manner also in the second replenishment apparatus 37b.

That is, according to the present first example, unlike the technique disclosed in Patent Document 1 described above, that is, unlike the technique disclosed in Patent Document 1 requiring performing of complicated processing such as obtaining a ratio between the amount of the first developer to be supplied to the first development apparatus and the amount of the second developer to be supplied to the second development apparatus and allocating the first drive time and the second drive time according to the ratio, it is possible to perform replenishment of two types of toners a and β with one drive source in a good balance without performing such complicated processing, in other words, by an extremely simple and uncomplicated manner. This is extremely advantageous for the configuration as in the present first example where the cost of the entire image forming apparatus 10 is reduced by performing replenishment of the two types of toners a and β by one drive source.

In the present first example, in particular, the CPU 200a that executes step S11 of the toner replenishment control task, that is, the CPU 200a that derives the necessary replenishment time Ts[X] for each toner is an example of a derivator according to the present disclosure. The CPU 200a that executes step S13 of the toner replenishment control task, that is, the CPU 200a that updates the accumulation necessary replenishment time Tz[X] of each toner is an example of the accumulator according to the present disclosure. Furthermore, the first replenishment motor 110a and the second replenishment motor 110b which are drive sources are driven under the control of the CPU 200a, and the CPU 200a responsible for controlling the first replenishment motor 110a and the second replenishment motor 110b is an example of a drive controller according to the present disclosure.

### Second Example

Next, the second example of the present disclosure will be described.

In the present first example described above, the forced replenishment threshold Tb common to each other is used for each toner, and the forced replenishment threshold Tb is assumed to be constant. However, in the present second example, an individual forced replenishment threshold Tb[X] is used for each toner. In addition, in the present second example, the forced replenishment threshold Tb[X] for each toner is set (changed) based on a mean printing rate Ra[X] which is the mean value of the printing rates Rp[X] for each toner pf the most recent N sheets.

That is, as described above, when the forced replenishment is frequently performed, printing is interrupted accordingly, and thus productivity is reduced. On the other hand, when the timing at which the forced replenishment is performed is late, there is a possibility that an image quality defect of density reduction occurs in the output image. When the replenishment amount of toner by forced replenishment is excessively large, the replenished toner is not sufficiently charged, that is, charging is insufficient, charging unevenness occurs, and another image quality defect of a fogging phenomenon in which a toner image is formed in a part where the toner image is not originally formed on the sheet may occur. Furthermore, when the replenishment amount of toner by forced replenishment is excessively large, the replenished toner may be scattered to the outside of (the housing of) the development apparatus 50. Therefore, it is important that the forced replenishment is performed at an appropriate timing.

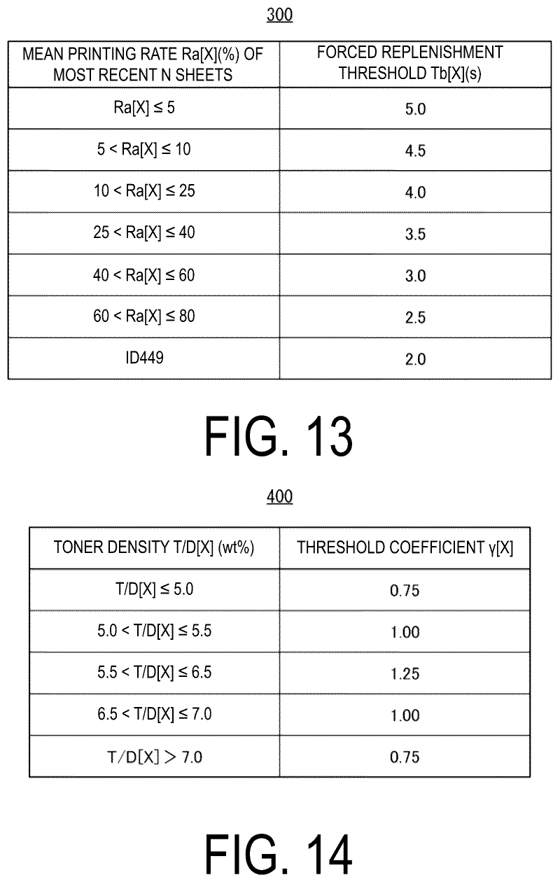

Therefore, in the present second example, the individual forced replenishment threshold Tb[X] is used for each toner as described above, and the forced replenishment threshold Tb[X] for each toner is set based on the mean printing rate Ra[X] which is the mean value of the printing rates Rp[X] for each toner pf the most recent N sheets. For this purpose, a forced replenishment threshold table 300 as illustrated in FIG. 13 is provided. The forced replenishment threshold table 300 is incorporated in the toner replenishment control program.

According to this forced replenishment threshold table 300, when the mean printing rate Ra[X] of the most recent N sheets is 5% or less, for example, a value of 5.0 s is set as the forced replenishment threshold Tb[X] for each toner. When the mean printing rate Ra[X] is over 5% and is 10% or less, a value of 4.5 s is set as the forced replenishment threshold Tb[X], and when the mean printing rate Ra[X] is over 10% and is 25% or less, a value of 4.0 s is set as the forced replenishment threshold Tb[X]. Furthermore, when the mean printing rate Ra[X] is over 25% and 40% or less, a time of 3.5 s is set as the forced replenishment threshold Tb[X], and when the mean printing rate Ra[X] is over 40% and 60% or less, a value of 3.0 s is set as the forced replenishment threshold Tb[X]. When the mean printing rate Ra[X] is over 60% and is 80% or less, a value of 2.0 s is set as the forced replenishment threshold Tb[X], and when the mean printing rate Ra[X] is over 80%, a value of 2.0 s is set as the forced replenishment threshold Tb[X].

That is, as the mean printing rate Ra[X] of the most recent N sheets is lower, a longer time is set as the forced replenishment threshold Tb[X], and as the mean printing rate Ra[X] of the most recent N sheets is higher, a shorter time is set as the forced replenishment threshold Tb[X]. In short, an appropriate forced replenishment threshold Tb[X] corresponding to the mean printing rate Ra[X] of the most recent N sheets is set for each toner. Thus, forced replenishment is performed at an appropriate timing according to the mean printing rate Ra[X] of the most recent N sheets for each toner.

The value of N is, for example, 5. When the value of N is excessively large, the timing at which the forced replenishment is performed is delayed and the above-described image quality defect may occur. On the other hand, when the value of N is excessively small, the forced replenishment is frequently performed and thus productivity may be reduced. The value of N being 5 was derived in view of them. However, the value of N is not limited to 5 and may be arbitrarily changeable.

Also in the present second example, the above-described toner replenishment control task is executed. In particular, in the initial check in step S1, in addition to checking the accumulation necessary replenishment time Tz[X] of each toner at the present time point, the mean printing rate Ra[X] of the most recent N sheets for each toner is checked. Then, at an appropriate stage after step S7 and before step S15, the mean printing rate Ra[X] of the most recent N sheets is calculated again, that is, updated, and the forced replenishment threshold table 300 is referred to, whereby the forced replenishment threshold Tb[X] corresponding to the updated mean printing rate Ra[X] is specified. Then, the specified forced replenishment threshold Tb[X] is applied as a comparison target of the accumulation necessary replenishment time Tz[X] in step S15.

As described above, according to the present second example, the forced replenishment is performed at an appropriate timing according to the mean printing rate Ra[X] of the most recent N sheets for each toner. Thus, it is possible to prevent the occurrence of image quality defects such as density reduction of an output image and a fogging phenomenon while suppressing the frequency of performing forced replenishment and keeping high productivity, and further, it is possible to prevent the replenished toner from scattering to the outside of (the housing of) the development apparatus 50.

### Third Example

Next, the third example of the present disclosure will be described.

The present third example is based on the present first example. In the present third example, for each toner, a threshold coefficient γ[X] corresponding to the toner density detection value T/D[X] by the toner density sensor 50b described above is multiplied by the forced replenishment threshold Tb, and the multiplication value γ[X] · Tb is applied as a comparison target of the accumulation necessary replenishment time Tz[X]. For this purpose, a threshold coefficient table 400 as illustrated in FIG. 14 is provided. The threshold coefficient table 400 is incorporated in the toner replenishment control program.

According to this threshold coefficient table 400, for each toner, for example, when the toner density detection value T/D[X] is 5.0 wt % or less, a value of 0.75 is multiplied by the forced replenishment threshold Tb as the threshold coefficient γ[X]. In this case, since the multiplication value γ[X] · Tb that is a comparison target of the accumulation necessary replenishment time Tz[X] is a value smaller than the forced replenishment threshold b, the forced replenishment the toner is easily performed. When the toner density detection value T/D[X] is over 5.0 wt % and 5.5 wt % or less, a value of 1.00 as the threshold coefficient γ[X] is multiplied by the forced replenishment threshold Tb. In this case, the multiplication value Y[X]. Tb that is a comparison target of the accumulation necessary replenishment time Tz[X] is equivalent to the forced replenishment threshold Tb. Furthermore, when the toner density detection value T/D[X] is over 5.5 wt % and 6.5 wt % or less, a value of 1.25 as the threshold coefficient γ[X] is multiplied by the forced replenishment threshold Tb. In this case, since the multiplication value γ[X] · Ta that is a comparison target of the accumulation necessary replenishment time Tz[X] is a value larger than the forced replenishment threshold Tb, the forced replenishment of toner is hardly performed. An appropriate value of the toner density T/D is, for example, 6.0 wt %.

When the toner density detection value T/D[X] is over 6.5 wt % and 7.0 wt % or less, a value of 1.00 as the threshold coefficient γ[X] is multiplied by the forced replenishment threshold Tb. In this case, the multiplication value γ[X]. Tb that is a comparison target of the accumulation necessary replenishment time Tz[X] is equivalent to the forced replenishment threshold Tb. When the toner density detection value T/D[X] is over 7.0 wt %, a value of 0.75 as the threshold coefficient [X] is multiplied by the forced replenishment threshold Tb. In this case, since the multiplication value γ[X] · Tb that is a comparison target of the accumulation necessary replenishment time Tz[X] is a value smaller than the forced replenishment threshold Tb, the forced replenishment of toner is easily performed.

That is, when the toner density detection value T/D[X] is 5.0 wt % or less, that is, when the toner density T/D is excessively lower than an appropriate value thereof, the forced replenishment threshold Tb is corrected so that forced replenishment the toner is easily performed. When the toner density T/D is excessively low, there is a possibility that the density of the output image decreases and the stirring unevenness of the developer occurs. Therefore, in order to avoid these disadvantages, the forced replenishment threshold Tb is corrected so that the forced replenishment the toner is easily performed.

Also when the toner density detection value T/D[X] is over 7.0 wt %, that is, when the toner density T/D is excessively higher than an appropriate value thereof, the forced replenishment threshold Tb is corrected so that the forced replenishment of toner is easily performed. When the toner density T/D is excessively high, there is a possibility that the toner in the development apparatus 50 (the developer accommodation chamber 50a) scatters to the outside of the development apparatus 50 or the above-described fogging phenomenon occurs. Therefore, in order to avoid these disadvantages, the forced replenishment threshold Tb is corrected so that the forced replenishment of the toner is easily performed.

When the toner density detection value T/D[X] is over 5.5 wt % and 6.5 wt % or less, that is, when the toner density T/D is approximately an appropriate value, the forced replenishment threshold Tb is corrected so that the forced replenishment of the toner is hardly performed. When the toner density T/D is approximately an appropriate value, there is almost no possibility that disadvantages such as a case where the toner density T/D is excessively high or excessively low occurs. Therefore, in order to further improve productivity, the forced replenishment threshold Tb is corrected so that the forced replenishment of the toner is hardly performed.

Also in the present third example, the above-described toner replenishment control task is executed. In particular, in the initial check in step S1, in addition to checking the accumulation necessary replenishment time Tz[X] of each toner at the present time point, the toner density detection value T/D[X] for each toner is checked. In step S1 or at an appropriate stage after step S1 and before step S15, the threshold coefficient γ[X] corresponding to the toner density detection value T/D[X] for each toner is specified with reference to the threshold coefficient table 400. Then, the specified threshold coefficient γ[X] is multiplied by the forced replenishment threshold Tb, and the multiplication value γ[X]. Tb is applied as a comparison target of the accumulation necessary replenishment time Tz[X] in step S15.

As described above, according to the present third example, for each toner, the multiplication value γ[X]. Tb of the threshold coefficient γ[X] corresponding to the toner density detection value T/D[X] and the forced replenishment threshold Tb is a comparison target with the accumulation necessary replenishment time Tz[X]. Thus, it is possible to further improve productivity while suppressing occurrence of disadvantages when the toner density T/D is excessively high or excessively low for each toner.

The present third example is based on the present first example, but may be based on the present second example. In this case, for each toner, a multiplication value γ[X]. Tb[X] of the threshold coefficient γ[X] and the forced replenishment threshold Tb[X] is a comparison target with the accumulation necessary replenishment time Tz[X].

### Other Application Examples

Each of the above examples is a specific example of the present disclosure, and does not limit the technical scope of the present disclosure. The present disclosure can be applied to aspects other than these examples.

For example, the developer is not limited to a two-component system, and may be a one-component system developer not containing a carrier. However, the third example is based on a two-component developer.

In each example, the case where the size of the sheet is the A4 size has been described, but the size of the sheet is not limited to the A4 size.

Furthermore, in each example, the image forming apparatus 10 employing the tandem-type color image former 26 has been described as an example, but the present disclosure can also be applied to an image forming apparatus employing a rotary-type color image former.

In addition, the image forming apparatus 10 in each example is a multifunction peripheral. However, the present disclosure can also be applied to an image forming apparatus other than the multifunction peripheral, such as a dedicated printing machine, a dedicated copy machine, or a dedicated fax machine.

The present disclosure can be provided not only in the form of an apparatus called an image forming apparatus, but also in the form of a method called a toner replenishment control method in an image forming apparatus.

1. An image forming apparatus that performs image formation processing by an electrophotographic method, the image forming apparatus comprising:
a first accommodation in which first toner is accommodated;
a first replenishment member that replenishes a first development unit with the first toner accommodated in the first accommodation;
a second accommodation in which second toner is accommodated;
a second replenishment member that replenishes a second development unit with the second toner accommodated in the second accommodation;
a drive source that selectively drives the first replenishment member and the second replenishment member;
a drive controller that controls the drive source;
a derivator that derives, based on image data to be subjected to the image formation processing, a first necessary replenishment time, which is a replenishment time of the first toner necessary for compensating for consumption of the first toner consumed by the first development unit, and a second necessary replenishment time, which is a replenishment time of the second toner necessary for compensating for consumption of the second toner consumed by the second development unit; and
an accumulator that accumulates a shortage of an actual replenishment time of the first toner by the first replenishment member with respect to the first necessary replenishment time every time the image formation processing is performed and obtains a first accumulation time, which is an accumulation value of the shortage, and that accumulates a shortage of an actual replenishment time of the second toner by the second replenishment member with respect to the second necessary replenishment time every time the image formation processing is performed and obtains a second accumulation time, which is an accumulation value of the shortage,
wherein when at least one of the first accumulation time and the second accumulation time is equal to or greater than a predetermined first threshold, the drive controller specifies the first accumulation time or the second accumulation time that is equal to or greater than the first threshold as one accumulation time, specifies the first replenishment member or the second replenishment member related to the one accumulation time as one replenishment member, drives the one replenishment member for the one accumulation time with a predetermined second threshold as an upper limit, and then stops drive of the one replenishment member, and further, according to another accumulation time, which is not the one accumulation time, of the first accumulation time and the second accumulation time and the one accumulation time, drives another replenishment member, which is not the one replenishment member, of the first replenishment member and the second replenishment member for the other accumulation time with the second threshold as an upper limit, or drives the one replenishment member for the one accumulation time with the second threshold as an upper limit, or controls the drive source so as to bring the one replenishment member and the other replenishment member into a stop state without driving both of the one replenishment member and the other replenishment member.

2. The image forming apparatus according to claim 1, wherein the drive controller specifies, as the one accumulation time, a longer one of the first accumulation time and the second accumulation time when both the first accumulation time and the second accumulation time are equal to or greater than the first threshold.

3. The image forming apparatus according to claim 2 further comprising:
a first toner density detector that detects a density of the first toner contained in a developer in the first development unit; and
a second toner density detector that detects a density of the second toner contained in a developer in the second development unit,
wherein when both the first accumulation time and the second accumulation time are equal to or greater than the first threshold and when the first accumulation time and the second accumulation time have a length equal to each other, the drive controller specifies, as the one accumulation time, the first accumulation time or the second accumulation time corresponding to a lower one of a density detection value by the first toner density detector and a density detection value by the second toner density detector.

4. The image forming apparatus according to claim 1, wherein the second threshold is a value equal to or greater than the first necessary replenishment time at a printing rate related to the first toner based on the image data is 50% and equal to or less than the first necessary replenishment time at the printing rate is 90%.

5. The image forming apparatus according to claim 1, wherein when at least one of the first accumulation time and the second accumulation time is equal to or greater than a predetermined third threshold, the drive controller controls the drive source so as to interrupt the image formation processing, drives the first replenishment member for the first accumulation time, and drive the second replenishment member for the second accumulation time.

6. A toner replenishment control method in an image forming apparatus that performs image formation processing by an electrophotographic method,
the image forming apparatus including
a first accommodation in which first toner is accommodated,
a first replenishment member that replenishes a first development unit with the first toner accommodated in the first accommodation,
a second accommodation in which second toner is accommodated,
a second replenishment member that replenishes a second development unit with the second toner accommodated in the second accommodation, and
a drive source that selectively drives the first replenishment member and the second replenishment member,
the toner replenishment control method comprising:
a drive control step of controlling the drive source, a derivation step of deriving, based on image data to be subjected to the image formation processing, a first necessary replenishment time, which is a replenishment time of the first toner necessary for compensating for consumption of the first toner consumed by the first development unit, and a second necessary replenishment time, which is a replenishment time of the second toner necessary for compensating for consumption of the second toner consumed by the second development unit, and
an accumulation step of accumulating a shortage of an actual replenishment time of the first toner by the first replenishment member with respect to the first necessary replenishment time every time the image formation processing is performed and obtaining a first accumulation time, which is an accumulation value of the shortage, and of accumulating a shortage of an actual replenishment time of the second toner by the second replenishment member with respect to the second necessary replenishment time every time the image formation processing is performed and obtaining a second accumulation time which is an accumulation value of the shortage,
wherein the drive control step includes,
when at least one of the first accumulation time and the second accumulation time is equal to or greater than a predetermined first threshold, specifying the first accumulation time or the second accumulation time that is equal to or greater than the first threshold as one accumulation time, and specifying the first replenishment member or the second replenishment member related to the one accumulation time as one replenishment member, then driving the one replenishment member for the one accumulation time with a predetermined second threshold as an upper limit, and then stopping drive of the one replenishment member, and further, according to another accumulation time, which is not the one accumulation time, of the first accumulation time and the second accumulation time and the one accumulation time, driving another replenishment member, which is not the one replenishment member, of the first replenishment member and the second replenishment member for the other accumulation time with the second threshold as an upper limit, or driving the one replenishment member for the one accumulation time with the second threshold as an upper limit, or controlling the drive source so as to bring the one replenishment member and the other replenishment member into a stop state without driving both of the one replenishment member and the other replenishment member.
